(19) United States
(12) Patent Application Publication
(10) Pub. No.: US 2025/0035831 A1
(43) Pub. Date: Jan. 30, 2025

(54) OPTICAL FILM, POLARIZING PLATE, AND IMAGE DISPLAY DEVICE

(71) Applicant: FUJIFILM Corporation, Tokyo (JP)

(72) Inventors: Naoya NISHIMURA, Kanagawa (JP); Yoshinori MAEDA, Kanagawa (JP); Yumi KATO, Kanagawa (JP); Toshikazu SUMI, Kanagawa (JP); Naoki KOITO, Kanagawa (JP); Yasukazu KUWAYAMA, Kanagawa (JP)

(73) Assignee: FUJIFILM Corporation, Tokyo (JP)

(21) Appl. No.: 18/898,108

(22) Filed: Sep. 26, 2024

Related U.S. Application Data
(63) Continuation of application No. PCT/JP2023/015101, filed on Apr. 14, 2023.

(30) Foreign Application Priority Data
May 2, 2022 (JP) 2022-076145
Jul. 22, 2022 (JP) 2022-116838
Feb. 8, 2023 (JP) 2023-017471
Mar. 2, 2023 (JP) 2023-031757

(51) Int. Cl. G02B 5/30; C08L 33/14; C09K 19/56; C09K 19/60

(52) U.S. Cl. CPC G02B 5/3016; C08L 33/14; C09K 19/56; C09K 19/601; C08L 2203/16

(57) ABSTRACT

An optical film, including a polarizing plate, and an image display device. The optical film includes, in the following order, a base material, an alignment film, and a liquid crystal layer, in which the alignment film contains at least one specific compound selected from the group consisting of a polymerizable macromolecule having a polymerizable group in a side chain and a polymer thereof, and a secondary ion intensity derived from the specific compound in the alignment film is measured by a time-of-flight secondary ion mass spectrometry while irradiating the alignment film with an ion beam from a surface on a liquid crystal layer side toward a surface on abase material side, a maximum value of the secondary ion intensity derived from the specific compound is present in a region from the surface of the base material to a 100 nm thickness position.

### CROSS-REFERENCE TO RELATED APPLICATIONS

This application is a Continuation of PCT International Application No. PCT/JP2023/015101 filed on Apr. 14, 2023, which was published under PCT Article 21(2) in Japanese, which claims priority under 35 U.S.C. § 119(a) to Japanese Patent Application No. 2022-076145 filed on May 2, 2022, Japanese Patent Application No. 2022-116838 filed on Jul. 22, 2022, Japanese Patent Application No. 2023-017471 filed on Feb. 8, 2023, and Japanese Patent Application No. 2023-031757 filed on Mar. 2, 2023. The above applications are hereby expressly incorporated by reference, in their entirety, into the present application.

### BACKGROUND OF THE INVENTION

### 1. Field of the Invention

The present invention relates to an optical film, a polarizing plate, and an image display device.

### 2. Description of the Related Art

Optical films such as an optical compensation sheet and a phase difference film are used in various image display devices from the viewpoints of image coloration elimination, viewing angle expansion, and the like.

A stretched birefringence film has been used as an optical film. However, in recent years, it has been suggested to use an light absorption anisotropic layer (liquid crystal layer) formed of a liquid crystal compound in place of the stretched birefringence film.

A linear polarizer or a circular polarizer is used in an image display device (for example, a liquid crystal display device) to control optical rotation or birefringence in display.

In the related art, iodine has been widely used as the dichroic substance in these polarizers. However, a light absorption anisotropic layer (liquid crystal layer) using a dichroic substance instead of iodine and utilizing the alignment of the liquid crystal compound has also been studied.

It is known that, in such a liquid crystal layer, to align the liquid crystal compound, an alignment film is provided on a base material (support) on which the liquid crystal layer is formed.

For example, WO2020/179864A discloses an aspect in which a support, a photo-alignment film formed of a composition containing a predetermined copolymer, and a light absorption anisotropic layer formed of a composition containing a liquid crystal compound and a dichroic substance are provided in this order.

### SUMMARY OF THE INVENTION

As a result of studying the optical film including a base material, an alignment film, and a liquid crystal layer in this order, described in WO2020/179864A and the like, the present inventors have found that, in a case of attempting to peel off the base material from the viewpoints of thin film formation, transfer, and the like, the peeling force is high and the peeling is difficult.

In addition, the present inventors have found that the peeling force of the base material can be reduced by adjusting a coating method of the alignment film or a prescription of the alignment film. However, it has been found that, depending on the peeling force of the base material, a problem occurs in that the base material is unintentionally peeled off in a case of a work such as peeling off of another member.

Therefore, an object of the present invention is to provide an optical film in which a base material can be easily peeled off in a case of peeling off the base material and adhesiveness between the base material and an alignment film can be sufficiently ensured during work other than peeling off of the base material, a polarizing plate, and an image display device.

As a result of intensive studies to achieve the above-described object, the present inventors have found that, in an optical film including a base material, an alignment film, and a liquid crystal layer in this order, in a case where the alignment film containing at least one specific compound selected from the group consisting of a polymerizable macromolecule having a polymerizable group in a side chain and a polymer of the polymerizable macromolecule, in which a maximum value of a secondary ion intensity derived from the specific compound is present in a region from a surface on a base material side to a 100 nm thickness position, is used, the base material can be easily peeled off in a case of peeling off the base material, and adhesiveness between the base material and the alignment film can be sufficiently ensured during work other than peeling off of the base material, and have completed the present invention.

That is, the present inventors have found that the object can be achieved with the following configuration.

[1] An optical film comprising, in the following order, a base material, an alignment film, and a liquid crystal layer, in which the alignment film contains at least one specific compound selected from the group consisting of a polymerizable macromolecule having a polymerizable group in a side chain and a polymer of the polymerizable macromolecule, and in a case where a secondary ion intensity derived from the specific compound in the alignment film is measured by a time-of-flight secondary ion mass spectrometry while irradiating the alignment film with an ion beam from a surface on a liquid crystal layer side toward a surface on a base material side, a maximum value of the secondary ion intensity derived from the specific compound is present in a region from the surface of the base material to a 100 nm thickness position.

[2] The optical film according to [1], in which the specific compound is a polymer of the polymerizable macromolecule.

[3] The optical film according to [1] or [2], in which the alignment film is a photo-alignment film.

[4] The optical film according to [3], in which the photo-alignment film is an alignment film formed of a composition for forming an alignment film, containing the polymerizable macromolecule and a photo-alignment compound, the polymerizable macromolecule has a radically polymerizable group, and the photo-alignment compound has a cationically polymerizable group.

[5] The optical film according to [4], in which the composition for forming an alignment film contains a polymerization initiator.

[6] The optical film according to [5], in which the polymerization initiator is a photo-radical polymerization initiator.

[7] The optical film according to any one of [1] to [6], in which a content of the specific compound is 0.2% to 20% by mass with respect to a mass of the alignment film.

[8] The optical film according to any one of [1] to [7], in which the liquid crystal layer contains a dichroic substance.

[9] The optical film according to any one of [1] to [8], in which a peeling force in a case of peeling off the base material from the alignment film is 0.03 to 0.40 N/25 mm.

[10] The optical film according to any one of [1] to [9], in which an absolute value of a difference between an SP value of the polymerizable macromolecule and an SP value of the base material is 1.7 MPa^{1/2} or less.

[11] The optical film according to any one of [1] to [10], in which a weight-average molecular weight of the polymerizable macromolecule is 5,000 to 100,000.

[12] The optical film according to any one of [1] to [11], in which the polymerizable group is an acryloyl group or a methacryloyl group.

[13] A polarizing plate comprising the optical film according to any one of [1] to [12].

[14] An image display device comprising the optical film according to any one of [1] to [12].

[15] An image display device comprising the polarizing plate according to [13].

According to the present invention, it is possible to provide an optical film in which a base material can be easily peeled off in a case of peeling off the base material and adhesiveness between the base material and an alignment film can be sufficiently ensured during work other than peeling off of the base material, a polarizing plate, and an image display device.

### DESCRIPTION OF THE PREFERRED EMBODIMENTS

Hereinafter, the present invention will be described in detail.

Description of configuration requirements described below may be made on the basis of representative embodiments of the present invention in some cases, but the present invention is not limited to such embodiments.

In the present specification, a numerical range expressed using “to” means a range that includes the preceding and succeeding numerical values of “to” as the lower limit value and the upper limit value, respectively.

In addition, in the present specification, for each component, one type of substance corresponding to each component may be used alone, or two or more types thereof may be used in combination. Here, in a case where two or more kinds of materials corresponding to respective components are used in combination, the content of the components indicates the total content of the combined materials unless otherwise specified.

In addition, in the present specification, the “(meth)acrylic” is a notation representing “acrylic” or “methacrylic”.

In the present specification, Re(λ) and Rth(λ) represent an in-plane retardation and a thickness-direction retardation at a wavelength k, respectively. Unless otherwise specified, the wavelength λ refers to 550 nm.

In addition, in the present specification, Re(λ) and Rth(λ) are values measured at the wavelength λ using AxoScan (manufactured by Axometrics, Inc.).

Specifically, by inputting an average refractive index ((nx+ny+nz)/3) and a film thickness (d (m)) to AxoScan,
in-Plane Slow Axis Direction (°)

$$Re ( λ ) = R 0 ( λ ) , and \\ Rth ( λ ) = ( ( nx + ny ) / 2 - nz ) \times d$$

are calculated.

Although R0 (λ) is displayed as a numerical value calculated by AxoScan, it means Re (λ).

### [Optical Film]

The optical film according to the embodiment of the present invention includes a base material, an alignment film, and a liquid crystal layer in this order.

In addition, the alignment film contains at least one specific compound selected from the group consisting of a polymerizable macromolecule having a polymerizable group in a side chain and a polymer of the polymerizable macromolecule.

Furthermore, in a case where a secondary ion intensity derived from the specific compound in the alignment film is measured by a time-of-flight secondary ion mass spectrometry (TOF-SIMS) while irradiating the alignment film with an ion beam from a surface on the liquid crystal layer side toward a surface on the base material side, a maximum value of the secondary ion intensity derived from the specific compound is present in a region from the surface of the base material to a 100 nm thickness position.

In the following description, the presence of the maximum value of the secondary ion intensity derived from the specific compound in a region from the surface of the base material to a 100 nm thickness position is also simply abbreviated as “the specific compound is unevenly distributed on the base material side”. As a method of confirming that the specific compound is unevenly distributed on the base material side, it can be confirmed by a method described in Examples which will be described later.

In addition, in a case where the alignment film contains two or more types of the specific compounds, it is sufficient that at least one type of the specific compound is unevenly distributed on the base material side.

In the present invention, as described above, in the optical film including the base material, the alignment film, and the liquid crystal layer in this order, by using the alignment film in which the specific compound is unevenly distributed on the base material side, the base material can be easily peeled off in a case of peeling off the base material and adhesiveness between the base material and the alignment film can be sufficiently ensured during work other than peeling off of the base material.

The reason why this effect is exhibited is not clear in detail, but the present inventors have presumed as follows.

That is, the present inventors have considered that, since the specific compound which is unevenly distributed in the alignment film on the base material side suppresses anchoring by other components during the formation of the optical film, and can be crosslinked with the surface of the substrate as necessary, and thus the peeling force of the base material can be adjusted to an appropriate range, the base material can be easily peeled off in a case of peeling off the base material and adhesiveness between the base material and the alignment film can be sufficiently ensured during work other than peeling off of the base material.

In the present invention, from the reason that the base material can be easily peeled off in a case of peeling off the base material and adhesiveness between the base material and the alignment film can be sufficiently ensured during work other than peeling off of the base material (hereinafter, abbreviated as “reason that the effect of the present invention is more excellent”), the peeling force (hereinafter, also abbreviated as a “peeling force of the base material”) in a case of peeling off the base material from the alignment film is preferably 0.03 to 0.40 N/25 mm and more preferably 0.05 to 0.35 N/25 mm.

Here, the peeling force of the base material is a peeling force in a case where an optical film including the base material, the alignment film, and the liquid crystal layer in this order is cut into 150 mm×25 mm, the surface of the optical film on the side opposite to the base material is fixed to a stage using a pressure sensitive adhesive (Opteria D692 manufactured by LINTEC Corporation) having a thickness of 15 m, and the base material is peeled off in a 1800 direction at a rate of 5 m/min in an environment of 25° C., and the peeling force can be measured with a digital force gauge RZ-1 manufactured by Aikoh Engineering Co., Ltd.

### [Base Material]

The base material included in the optical film according to the embodiment of the present invention is not particularly limited, and a known base material can be used. In particular, it is preferable to use a transparent base material. The transparent base material means a base material in which the transmittance of visible light is 60% or more, and the transmittance is preferably 80% or more and more preferably 90% or more.

Examples of such a base material include a glass substrate and a polymer film.

Examples of a material of the polymer film include cellulose-based polymers; acrylic polymers having an acrylic acid ester polymer such as polymethyl methacrylate and a lactone ring-containing polymer; thermoplastic norbornene-based polymers; polycarbonate-based polymers; polyester-based polymers such as polyethylene terephthalate and polyethylene naphthalate; styrene-based polymers such as polystyrene and an acrylonitrile-styrene copolymer; polyolefin-based polymers such as polyethylene, polypropylene, and an ethylene-propylene copolymer; vinyl chloride-based polymers; amide-based polymers such as nylon and aromatic polyamide; imide-based polymers; sulfone-based polymers; polyether sulfone-based polymers; polyether ether ketone-based polymers; polyphenylene sulfide-based polymers; vinylidene chloride-based polymers; vinyl alcohol-based polymers; vinyl butyral-based polymers; arylate-based polymers; polyoxymethylene-based polymers; epoxy-based polymers; polymers obtained by mixing these polymers; and the like.

Among these, a polymer film (cellulose acylate-based film) formed of a cellulose-based polymer, particularly, a cellulose acylate-based polymer is preferable.

A thickness of the base material is not particularly limited, but is preferably 10 to 100 μm and more preferably 30 to 80 μm.

### [Alignment Film]

As described above, the alignment film included in the optical film according to the embodiment of the present invention contains at least one specific compound selected from the group consisting of a polymerizable macromolecule having a polymerizable group in a side chain and a polymer of the polymerizable macromolecule, and the specific compound is unevenly distributed on the base material side.

### <Specific Compound>

In the polymerizable macromolecule which is one aspect of the specific compound, the polymerizable group contained in the side chain is not particularly limited, but is preferably a polymerizable group which is radically polymerizable or cationically polymerizable.

Here, examples of the radically polymerizable group (photocrosslinkable group) include a (meth)acryloyl group, an acrylamide group, a vinyl group, a styryl group, an allyl group, and the like.

In addition, examples of the cationically polymerizable group (thermally crosslinkable group) include a vinyl ether group, an oxiranyl group, and an oxetanyl group.

In the present invention, from the reason that the effect of the present invention is more excellent, the polymerizable group is preferably a (meth)acryloyl group.

In addition, in the present invention, it is preferable that the above-described polymerizable macromolecule does not have a photo-alignment group described in a photo-alignment compound which will be described later.

A structure of the main chain of the above-described polymerizable macromolecule is not particularly limited, and examples thereof include known structures. For example, a skeleton selected from the group consisting of a (meth)acrylic skeleton, a styrene-based skeleton, a siloxane-based skeleton, a cycloolefin-based skeleton, a methylpentene-based skeleton, an amide-based skeleton, and an aromatic ester-based skeleton is preferable.

Among these, the skeleton selected from the group consisting of the (meth)acrylic skeleton, the siloxane-based skeleton, and the cycloolefin-based skeleton is more preferable, and the (meth)acrylic skeleton is still more preferable.

In the present invention, from the reason that the effect of the present invention is more excellent, it is preferable that the above-described polymerizable macromolecule has a repeating unit represented by Formula (1).

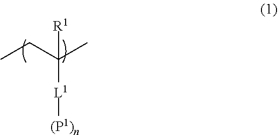

R¹ represents a hydrogen atom or an alkyl group having 1 to 4 carbon atoms.
L¹ represents a single bond or an (n+1)-valent linking group. For example, in a case where n is 1, L¹ represents a divalent linking group, and in a case where n is 2, L¹ represents a trivalent linking group. In a case where L¹ is a single bond, n represents 1.

Examples of the divalent linking group include a divalent aliphatic hydrocarbon group (for example, an alkylene group) which may have a substituent, an arylene group which may have a substituent, a heteroarylene which may have a substituent, —O—, —CO—, —NH—, and a group obtained by combining two or more of these groups. Examples of the above-described group obtained by combining two or more of these groups include a divalent aliphatic hydrocarbon group which may have a —CO—O-substituent, a divalent aliphatic hydrocarbon group which may have —O— and a —CO—O-substituent, a divalent aliphatic hydrocarbon group which may have —NH— and a —CO—O-substituent, and a divalent aliphatic hydrocarbon group which may have a —O—CO—NH-substituent.

Examples of the trivalent linking group include a trivalent aliphatic hydrocarbon group which may have a substituent, a trivalent aromatic group which may have a substituent, a nitrogen atom (>N—), and a group obtained by combining these groups and the above-described divalent linking group.

P¹ represents a polymerizable group. Examples of the polymerizable group include the above-described polymerizable group which is radically polymerizable or cationically polymerizable.

n represents an integer of 1 or more. Among these, from the reason that the effect of the present invention is more excellent, n is preferably 1 or 2 and more preferably 1.

A content of the repeating unit represented by Formula (1) is preferably 20% by mass or more, more preferably 30% by mass or more, and still more preferably 50% by mass or more with respect to the total mass of all repeating units of the polymerizable macromolecule. The upper limit thereof is not particularly limited, but examples thereof include 100% by mass and in many cases, the upper limit is 95% by mass or less.

Examples of the repeating unit represented by Formula (1) include repeating units shown in Table 1 below, and these may be used alone or in combination of two or more types thereof.

TABLE 1

| Number | Structure |
|---|---|
| A1 | 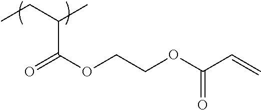 |
| A2 | 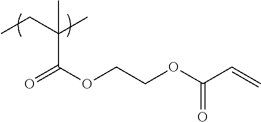 |
| A3 | 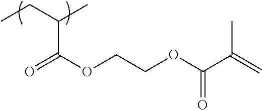 |
| A4 | 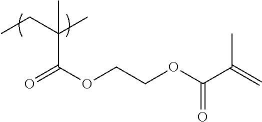 |
| A5 | 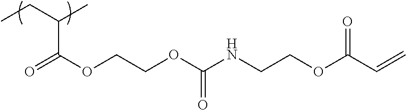 |
| A6 | 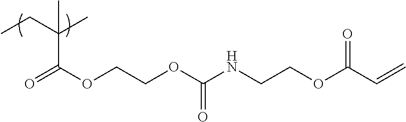 |
| A7 | 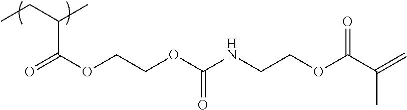 |
| A8 | 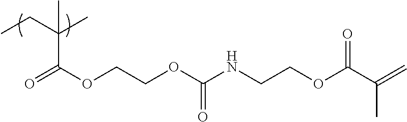 |
| A9 | 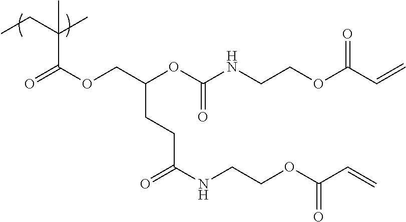 |
| A10 | 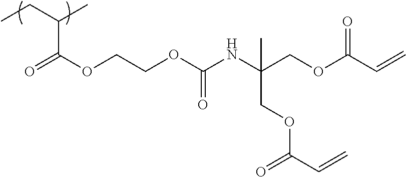 |
| A11 | 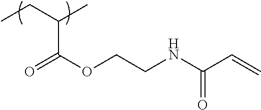 |
| A12 | 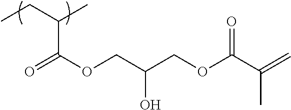 |
| A13 | 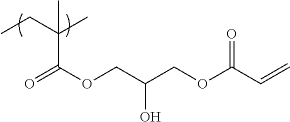 |
| A14 | 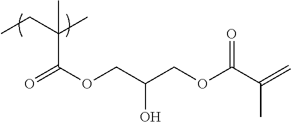 |
| A15 | 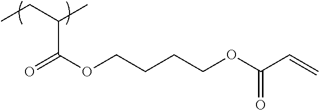 |
| A16 | 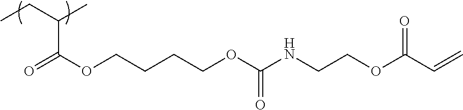 |
| A17 | 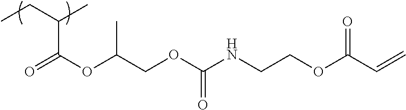 |
| A18 | 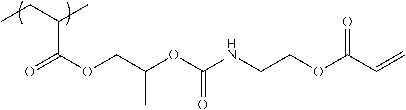 |
| A19 | 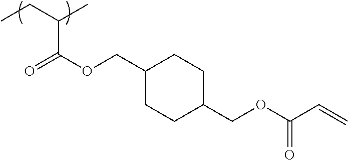 |
| A20 | 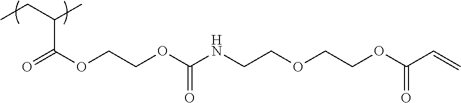 |

The polymerizable macromolecule may have other repeating units in addition to the repeating unit represented by Formula (1) described above.

From the reason that the effect of the present invention is more excellent, examples of the other repeating units include a repeating unit represented by Formula (2).

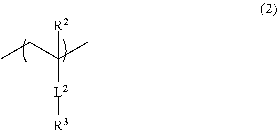

R² represents a hydrogen atom or an alkyl group having 1 to 4 carbon atoms.
L² represents a single bond or a divalent linking group. Examples of the divalent linking group include the groups exemplified by the divalent linking group represented by L¹ described above.
R³ represents an aliphatic hydrocarbon group which may have a substituent or a group in which one or more of —CH₂-'s constituting an aliphatic hydrocarbon group are substituted with —O—, —S—, —NH—, —N(Q)-, or —CO—. Q represents a substituent.

The number of carbon atoms in the above-described aliphatic hydrocarbon group is not particularly limited, but is preferably 1 to 20 and more preferably 1 to 10.

The aliphatic hydrocarbon group may be linear or branched. In addition, the aliphatic hydrocarbon group may have a cyclic structure.

The substituent is not particularly limited, and examples thereof include an alkyl group, an alkoxy group, an alkyl-substituted alkoxy group, a cyclic alkyl group, an aryl group (for example, a phenyl group and a naphthyl group), a cyano group, an amino group, a nitro group, an alkylcarbonyl group, a sulfo group, and a hydroxyl group.

In a case where the polymerizable macromolecule includes other repeating units, a content of the other repeating units (for example, the repeating unit represented by Formula (2) described above) is not particularly limited, but is preferably 80% by mass or less, more preferably 50% by mass or less, and still more preferably 30% by mass or less with respect to the total mass of all repeating units of the polymerizable macromolecule. The lower limit is not particularly limited, and examples thereof include 5% by mass or more.

Examples of the other repeating units include repeating units shown in Table 2 below, and these may be used alone or in combination of two or more types thereof.

TABLE 2

| Number | Structure |
|---|---|
| B1 | 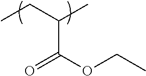 |
| B2 | 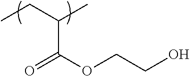 |
| B3 | 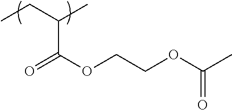 |
| B4 | 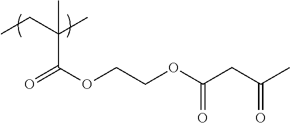 |
| B5 | 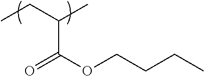 |
| B6 | 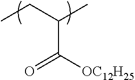 |

In the present invention, the peel strength of the substrate is easily adjusted to be in a range of 0.05 to 0.35 N/25 mm, and as a result, the effect of the present invention is more excellent. Therefore, the absolute value of the difference between the SP value of the above-described polymerizable macromolecule and the SP value of the above-described base material is preferably 1.7 MPa^{1/2} or less. The lower limit is not particularly limited and, examples thereof include 0.

Here, the SP value is intended to be a non-dispersive force component δa of the SP value calculated by the method of Hoy et al. (see “PROPERTIES OF POLYMERS (ED.3)”, VAN KREVELEN, D. W., Elsevier (1990)).

That is, the δa value can be calculated by Expression (X) by using the three-dimensional SP values (δd, δp, δh) calculated by the method of Hoy et al.

$$δ a = {( δ {p}^{2} + δ {h}^{2} )}^{0.5} \qquad Expression ( X )$$

According to the method of Hoy et al., each of the values of δd, δp, and δh can be calculated from the chemical structural formula of the compound to be obtained.

In a case of a copolymer consisting of a plurality of repeating units, a squared value (δd², δp², δh²) of a three-dimensional SP value of the copolymer can be calculated by multiplying a volume fraction of each repeating unit by a squared value (δd², δp², δh²) of a three-dimensional SP value of each repeating unit to obtain a sum thereof, and the obtained squared value can be substituted into Expression (X) to obtain a δa value of the copolymer.

In the present invention, from the reason that the effect of the present invention is more excellent, the weight-average molecular weight of the polymerizable macromolecule is preferably 5,000 to 100,000 and more preferably 7,500 to 50,000.

Here, the weight-average molecular weight is a value measured by a gel permeation chromatography (GPC) method under the following conditions.
Solvent (eluent): tetrahydrofuran (THF)
Device name: TOSOH HLC-8320GPC
Columns: three columns of TOSOH TSKgel Super HZM-H (4.6 mm×15 cm) connected to each other in use
Column temperature: 40° C.
Sample concentration: 0.1% by mass
Flow rate: 1.0 ml/min
Calibration curve: TSK standard polystyrene manufactured by TOSOH Corporation, calibration curves of 7 samples with Mw of 2,800,000 to 1,050 (Mw/Mn=1.03 to 1.06) are used

In the present invention, from the reason that the effect of the present invention is more excellent, it is preferable that the specific compound is a polymer of the above-described polymerizable macromolecule, that is, a crosslinked substance of the above-described polymerizable macromolecule.

In the present invention, from the reason that the alignment degree of the liquid crystal layer described later is increased, the content of the specific compound is preferably 0.2% to 20% by mass, more preferably 0.3% to 10% by mass, and still more preferably 0.4% to 8% by mass with respect to the mass of the alignment film.

A thickness of the above-described alignment film is not particularly limited, but is preferably 0.1 to 10 m, and more preferably 0.5 to 5 m.

In the alignment film included in the optical film according to the embodiment of the present invention, requirements other than that the above-described specific compound is unevenly distributed on the base material side are not particularly limited. The liquid crystal layer which will be later can be placed in a desired alignment state, the alignment film may be a rubbing treatment alignment film formed by rubbing treatment, or may be a photo-alignment film formed by light irradiation. In particular, a photo-alignment film is preferable.

In addition, in the alignment film included in the optical film according to the embodiment of the present invention, since the direction of the alignment regulating force is easily changed according to the purpose, it is possible to freely control the liquid crystal alignment direction of the liquid crystal layer which will be described later. For example, the direction of the alignment regulating force can be easily changed by changing the vibration direction of the polarization during the polarization exposure in a case of the photo-alignment treatment or by changing the direction of the rubbing in a case of the rubbing treatment. In particular, in a case where the production by roll-to-roll is assumed, for the long-length alignment film, the direction of the alignment regulating force can be easily selected from any of 0° to 900 with respect to the longitudinal direction of the long-length alignment film. Furthermore, in a case where the bonding with the other members by roll-to-roll is assumed, the axis angle with the other members can be changed according to the application to be required and the production process can be optimized.

### <Photo-Alignment Film>

A photo-alignment compound used for the photo-alignment film formed by irradiation with light is described in a plurality of documents. In the present invention, preferable examples thereof include azo compounds described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B, aromatic ester compounds described in JP2002-229039A, maleimide and/or alkenyl-substituted nadimide compounds having photo-alignment units described in JP2002-265541A and JP2002-317013A, photocrosslinkable silane derivatives described in JP4205195B and JP4205198B, and photocrosslinkable polyimides, polyamides, and esters described in JP2003-520878A, JP2004-529220A, and JP4162850B. Azo compounds, photocrosslinkable polyimides, polyamides, and esters are more preferable.

Among these, a photosensitive compound having a photo-alignment group which generates at least one of dimerization or isomerization by the action of light is preferably used as the photo-alignment compound.

In addition, examples of the photo-alignment group include a group having a cinnamic acid (cinnamoyl) structure (skeleton), a group having a coumarin structure (skeleton), a group having a chalcone structure (skeleton), a group having a benzophenone structure (skeleton), and a group having an anthracene structure (skeleton). Among these groups, a group having a cinnamoyl structure or a group having a coumarin structure is preferable, and a group having a cinnamoyl structure is more preferable.

In addition, the above-described photosensitive compound having a photo-alignment group may further have a crosslinkable group.

As the crosslinkable group, a thermally crosslinkable group which causes a curing reaction due to the action of heat and a photocrosslinkable group which causes a curing reaction due to the action of light are preferable, and the crosslinkable group may be a crosslinkable group which contains both a thermally crosslinkable group and a photocrosslinkable group.

Examples of the crosslinkable group include at least one selected from the group consisting of an epoxy group, an oxetanyl group, a group represented by —NH—CH₂—O—R (R represents a hydrogen atom or an alkyl group having 1 to 20 carbon atoms), a group having an ethylenically unsaturated double bond, and a block isocyanate group. Among these, an epoxy group, an oxetanyl group, or a group having an ethylenically unsaturated double bond is preferable.

A 3-membered cyclic ether group is also referred to as the epoxy group, and a 4-membered cyclic ether group is also referred to as the oxetanyl group.

In addition, specific examples of the group having an ethylenically unsaturated double bond include a vinyl group, an allyl group, a styryl group, an acryloyl group, and a methacryloyl group. An acryloyl group or a methacryloyl group is preferable.

To a photo-alignment film formed from the above-described material, linearly polarized light or unpolarized light is applied to produce a photo-alignment film.

In the present specification, the “irradiation with linearly polarized light” and the “irradiation with unpolarized light” are operations for causing a photoreaction in the photo-alignment material. A wavelength of the light to be used varies depending on the photo-alignment material to be used, and is not particularly limited as long as the wavelength is required for the photoreaction. The peak wavelength of the light used for light irradiation is preferably 200 nm to 700 nm, and ultraviolet light having a peak wavelength of 400 nm or less is more preferable.

The light source used for light irradiation is a usually used light source, and examples thereof include lamps such as a tungsten lamp, a halogen lamp, a xenon lamp, a xenon flash lamp, a mercury lamp, a mercury/xenon lamp, and a carbon arc lamp, various lasers [for example, a semiconductor laser, a helium/neon laser, an argon ion laser, a helium/cadmium laser, and an YAG (yttrium/aluminum/garnet) laser], light emitting diodes, and cathode ray tubes.

As a method of obtaining linearly polarized light, a method using a polarizing plate (for example, an iodine polarizing plate, a dichroic dye polarizing plate, or a wire grid polarizing plate), a method using a prism-based element (for example, a Glan-Thompson prism) or a reflective polarizer for which a Brewster's angle is used, or a method using light emitted from a laser light source having polarized light can be employed. Only light having a necessary wavelength may be selectively applied by using a filter, a wavelength conversion element, or the like.

In a case where linearly polarized light is used as light for irradiation, a method of irradiating the alignment film with light from an upper surface or a rear surface in a direction vertical or oblique to the alignment film surface is employed. Although the incidence angle of the light varies depending on the photo-alignment material, the incidence angle is preferably 0° to 900 (vertical), and more preferably 40° to 90°.

In a case where unpolarized light is used, the alignment film is irradiated with unpolarized light from an oblique direction. The incidence angle of the light is preferably 10° to 80°, more preferably 20° to 60°, and still more preferably 30° to 50°.

The irradiation time is preferably 1 minute to 60 minutes, and more preferably 1 minute to 10 minutes.

In a case where patterning is required, a method of performing light irradiation using a photomask as many times as necessary for pattern preparation, or a pattern writing method using laser beam scanning can be employed.

In the present invention, the above-described photo-alignment film is preferably an alignment film formed of a composition for forming an alignment film, containing the polymerizable macromolecule and the photo-alignment compound (particularly, the photosensitive compound having a photo-alignment group), which are described above.

In addition, the above-described polymerizable macromolecule preferably has a radically polymerizable group (photocrosslinkable group) as the polymerizable group, and the above-described photo-alignment compound preferably has a cationically polymerizable group (thermally crosslinkable group).

In addition, in the present invention, the composition for forming an alignment film preferably contains a polymerization initiator.

The polymerization initiator is not particularly limited, and examples thereof include a photoradical polymerization initiator and a thermal cationic polymerization initiator, depending on the form of the polymerization reaction.

As the polymerization initiator, a photoradical polymerization initiator which can initiate a polymerization reaction by irradiation of ultraviolet rays is preferable.

Examples of the photoradical polymerization initiator include an α-carbonyl compound, acyloin ether, an α-hydrocarbon-substituted aromatic acyloin compound, a polynuclear quinone compound, a combination of a triarylimidazole dimer and p-aminophenyl ketone, an acridine and phenazine compound, an oxadiazole compound, and an acylphosphine oxide compound.

In a case where the composition for forming an alignment film contains a photoradical polymerization initiator, a content of the photoradical polymerization initiator is preferably 0.1% to 10% by mass and more preferably 1% to 5% by mass with respect to the total solid content of the composition for forming an alignment film.

In addition, in a case where the composition for forming an alignment film contains a thermal cationic polymerization initiator, a content of the thermal cationic polymerization initiator is preferably 1% to 30% by mass and more preferably 4% to 20% by mass with respect to the total solid content of the composition for forming an alignment film.

In the present invention, the composition for forming an alignment film may contain other additives other than the above-described components.

Examples of the other additives include a compound added for the purpose of adjusting the refractive index of the alignment film. From the viewpoint of compatibility with the above-described photo-alignment compound, such a compound is preferably a compound having a hydrophilic group and/or a (meth)acryloyloxy group, and can be added in an amount that does not significantly reduce the alignment ability. Examples of the hydrophilic group include a hydroxyl group, a carboxyl group, a sulfo group, and an amino group.

The alignment film included in the optical film according to the embodiment of the present invention is preferably an alignment film in which an average refractive index at a wavelength of 550 nm is 1.55 or more and 1.8 or less. From the viewpoint of improving the antireflection property, a difference in refractive index from the liquid crystal layer (light absorption anisotropic layer) is preferably 0.1 or less and more preferably 0.05 or less.

In addition, examples of the other additives include a compound added for the purpose of adjusting the elastic modulus of the alignment film. Examples of such a compound include a crosslinking agent, a filler, a plasticizer, and the like. Among these, from the viewpoint of not deteriorating the alignment ability, a crosslinking agent is preferable. In addition, it is preferable that the crosslinking group included in the crosslinking agent is capable of reacting with the photo-alignment group included in the photosensitive compound. In addition, it is also preferable that the crosslinking agent has a plurality of crosslinkable groups in one molecule. Preferred examples of the crosslinking agent include compounds described in paragraphs [0102] to [0107] of WO2022/071054A.

In addition, examples of the other additives include an adhesion improver and a surfactant. Preferred examples of the adhesion improver include reactive additives described in paragraphs [0123] to [0129] of JP2019-91088A.

Furthermore, in the present invention, the composition for forming an alignment film preferably contains a solvent.

Examples of the solvent include ketones (for example, acetone, 2-butanone, methyl isobutyl ketone, cyclopentanone, and cyclohexanone), ethers (for example, dioxane and tetrahydrofuran), aliphatic hydrocarbons (for example, hexane), alicyclic hydrocarbons (for example, cyclohexane), aromatic hydrocarbons (for example, toluene, xylene, and trimethylbenzene), halogenated carbons (for example, dichloromethane, dichloroethane, dichlorobenzene, and chlorotoluene), esters (for example, methyl acetate, ethyl acetate, and butyl acetate), water, alcohols (for example, ethanol, isopropanol, butanol, and cyclohexanol), cellosolves (for example, methyl cellosolve and ethyl cellosolve), cellosolve acetates, sulfoxides (for example, dimethyl sulfoxide), and amides (for example, dimethylformamide and dimethylacetamide).

The solvents may be used alone or in combination of two or more types thereof.

### [Liquid Crystal Layer]

The liquid crystal layer included in the optical film according to the embodiment of the present invention is a layer in which an alignment state of the liquid crystal compound is fixed.

### <Liquid Crystal Compound>

As such a liquid crystal compound, both a polymer liquid crystal compound and a low-molecular-weight liquid crystal compound can be used.

Here, the “polymer liquid crystal compound” refers to a liquid crystal compound having a repeating unit in the chemical structure.

In addition, the “low-molecular-weight liquid crystal compound” refers to a liquid crystal compound having no repeating unit in the chemical structure.

Examples of the polymer liquid crystal compound include thermotropic liquid crystal polymers described in JP2011-237513A and polymer liquid crystal compounds described in paragraphs [0012] to [0042] of WO2018/199096A.

Examples of the low-molecular-weight liquid crystal compound include liquid crystal compounds described in paragraphs [0072] to [0088] of JP2013-228706A. Among these, a smectic liquid crystal compound is preferable.

Examples of such a liquid crystal compound include those described in paragraphs [0019] to [0140] of WO2022/014340A, the description of which is incorporated herein by reference.

The content of the liquid crystal compound is preferably in a range of 50% to 99% by mass and more preferably in a range of 75% to 90% by mass with respect to the total mass of the liquid crystal layer.

### <Dichroic Substance>

In the present invention, from the viewpoint of functioning the above-described liquid crystal layer as a light absorption anisotropic layer, the liquid crystal layer preferably contains a dichroic substance.

Here, the dichroic substance means a coloring agent having different absorbances depending on the direction. The dichroic substance may or may not exhibit liquid crystallinity.

The dichroic substance is not particularly limited, and examples thereof include a visible light absorbing substance (dichroic coloring agent), a light emitting substance (fluorescent substance and phosphorescent substance), an ultraviolet absorbing substance, an infrared absorbing substance, a non-linear optical substance, a carbon nanotube, and an inorganic substance (for example, quantum rod). Further, dichroic substances (dichroic coloring agents) known in the related art can be used.

Specific examples thereof include those described in paragraphs [0067] to [0071] of JP2013-228706A, paragraphs [0008] to [0026] of JP2013-227532A, paragraphs [0008] to [0015] of JP2013-209367A, paragraphs [0045] to [0058] of JP2013-14883A, paragraphs [0012] to [0029] of JP2013-109090A, paragraphs [0009] to [0017] of JP2013-101328A, paragraphs [0051] to [0065] of JP2013-37353A, paragraphs [0049] to [0073] of JP2012-63387A, paragraphs [0016] to [0018] of JP1999-305036A (JP-H11-305036A), paragraphs [0009] to [0011] of JP2001-133630A, paragraphs [0030] to [0169] of JP2011-215337A, paragraphs [0021] to [0075] of JP2010-106242A, paragraphs [0011] to [0025] of JP2010-215846A, paragraphs [0017] to [0069] of JP2011-048311A, paragraphs [0013] to [0133] of JP2011-213610A, paragraphs [0074] to [0246] of JP2011-237513A, paragraphs [0005] to [0051] of JP2016-006502A, paragraphs [0014] to [0032] of JP2018-053167A, paragraphs [0014] to [0033] of JP2020-11716A, paragraphs [0005] to [0041] of WO2016/060173A, paragraphs [0008] to [0062] of WO2016/136561A, paragraphs [0014] to [0033] of WO2017/154835A, paragraphs [0014] to [0033] of WO2017/154695A, paragraphs [0013] to [0037] of WO2017/195833A, paragraphs [0014] to [0034] of WO2018/164252A, paragraphs [0021] to [0030] of WO2018/186503A, paragraphs [0043] to [0063] of WO2019/189345A, paragraphs [0043] to [0085] of WO2019/225468A, paragraphs [0050] to [0074] of WO2020/004106A, and paragraphs [0015] to [0038] of WO2021/044843A.

As the dichroic substance, a dichroic azo coloring agent compound is preferable.

The dichroic azo coloring agent compound means an azo coloring agent compound having different absorbances depending on directions. The dichroic azo coloring agent compound may or may not exhibit liquid crystallinity. In a case where the dichroic azo coloring agent compound exhibits liquid crystallinity, it may exhibit any of nematic properties or smectic properties may be exhibited. The temperature range in which the liquid crystal phase is exhibited is preferably room temperature (approximately 20° C. to 28° C.) to 300° C., and from the viewpoints of handleability and production suitability, more preferably 50° C. to 200° C.

In the present invention, from the viewpoint of tint adjustment, it is preferable to use at least at least one coloring agent compound (first dichroic azo coloring agent compound) having a maximal absorption wavelength in a wavelength range of 560 to 700 nm and at least one coloring agent compound (second dichroic azo coloring agent compound) having a maximal absorption wavelength in a wavelength range of 455 nm or more and less than 560 nm.

In the present invention, three or more dichroic azo coloring agent compounds may be used in combination. For example, from the viewpoint of making the light absorption anisotropic layer close to black, it is preferable to use the first dichroic azo coloring agent compound, the second dichroic azo coloring agent compound, and at least one coloring agent compound (third dichroic azo coloring agent compound) having a maximal absorption wavelength in a wavelength range of 380 nm or more and less than 455 nm in combination.

In the present invention, the dichroic azo coloring agent compound preferably has a crosslinkable group.

Examples of the crosslinkable group include a (meth)acryloyl group, an epoxy group, an oxetanyl group, and a styryl group, and among these, a (meth)acryloyl group is preferable.

A content of the dichroic substance is not particularly limited, but from the reason that the alignment degree of the light absorption anisotropic layer to be formed is increased, the content is preferably 3% by mass or more, more preferably 8% by mass or more, and still more preferably 10% by mass or more with respect to the total mass of the light absorption anisotropic layer. The upper limit value of the content of the dichroic substance is not particularly limited, but is preferably 30% by mass or less, more preferably 29% by mass or less, and still more preferably 25% by mass or less with respect to the total mass of the light absorption anisotropic layer. In a case where a plurality of dichroic substances are used in combination, the total amount of the plurality of dichroic substances is preferably within the above range.

In addition, from the reason that the alignment degree of the light absorption anisotropic layer to be formed is increased, the content of the dichroic substance is preferably 10 to 400 mg/cm³, more preferably 30 to 200 mg/cm³, and still more preferably 40 to 150 mg/cm³. In a case where a plurality of dichroic substances are used in combination, the total amount of the plurality of dichroic substances is preferably within the above range.

Here, the content (mg/cm³) of the dichroic substance is obtained by measuring a solution, obtained by dissolving an optical laminate having the light absorption anisotropic layer, or an extraction liquid, obtained by immersing an optical laminate in a solvent, using high performance liquid chromatography (HPLC), but the measurement method is not limited to the above-described method. In addition, the quantification can be performed by using the dichroic substance contained in the light absorption anisotropic layer as a standard sample.

Examples of the method of calculating the content of the dichroic substance include a method in which the volume is calculated by multiplying the thickness of the light absorption anisotropic layer obtained from a microscopic observation image of a cross section of the optical laminate by the area of the optical laminate used for measuring the coloring agent amount, and is divided by the coloring agent amount measured by HPLC to calculate the content of the coloring agent.

### <Other Components>

In the present invention, the above-described liquid crystal layer may contain an adhesion improver, a surfactant, a plasticizer, a non-liquid crystalline polymerizable compound, a polymer, or the like, in addition to the above-described components.

Here, examples of the adhesion improver include reactive additives described in paragraphs [0123] to [0129] of JP2019-91088A and boronic acid monomers described in paragraphs [0015] to [0028] of WO2015/053359A. The content of the adhesion improver is preferably 0.1% to 20%, more preferably 0.3% to 10.0%, and still more preferably 0.5% to 5.0% with respect to the total mass of the solid content in the liquid crystal layer.

As the surfactant, it is preferable to use a compound having a so-called leveling function of making a coated film flat. For example, a fluorine atom-containing compound, a silicon atom-containing compound, or a polyacrylate compound can be used. Specifically, the surfactant can be used with reference to compounds and addition amounts described in specifications and examples of WO2021/002333A, WO2022/014342A, WO2022/014340A, paragraphs [0031] to [0033] of JP2020-98349A, paragraphs [0032] to [0036] of JP2020-98349A, WO2023/054164A, and the like.

In particular, from the viewpoint of reducing environmental pollution, the surfactant is preferably a silicon atom-containing compound or a polyacrylate compound, and more preferably a compound having a branched siloxane structure. In particular, the copolymer (surfactant) described in [Table 1] of WO2023/054164A is preferable. A content of the surfactant is preferably 0.01% to 10%, more preferably 0.01% to 6.0%, and still more preferably 0.05% to 3.0% with respect to the total mass of the solid content of the liquid crystal layer.

From the same viewpoint of reducing environmental pollution, a content rate of the fluorine atom in the surfactant is preferably low, and the content rate of the compound is preferably 10% or less, more preferably 5% or less, and still more preferably 3% or less, in terms of weight. The lower limit is most preferably 0%, but a trace amount (for example, 0.01% to 1.0%) may be contained in a range where the influence on environmental pollution is small.

A thickness of the above-described liquid crystal layer is not particularly limited, but is preferably 0.1 to 10 m and more preferably 0.5 to 5 m.

### <Production Method of Liquid Crystal Layer (Light Absorption Anisotropic Layer)>

A method for producing the light absorption anisotropic layer is not particularly limited, but from the viewpoint that the alignment degree of the dichroic substance is further increased, a method (hereinafter, also referred to as “the present production method”) including, in the following order, a step of applying a composition for forming a light absorption anisotropic layer, which contains the above-described liquid crystal compound, the above-described dichroic substance, and other components, onto the above-described alignment film to form a coating film (hereinafter, also referred to as “a coating film forming step”) and a step of aligning the liquid crystal components contained in the coating film (hereinafter, also referred to as “an alignment step”) is preferable.

The liquid crystal component is a component which includes not only the above-described liquid crystal compound but also a dichroic substance having liquid crystallinity.

Hereinafter, each step will be described.

The coating film forming step is a step of coating an alignment film with the composition for forming a light absorption anisotropic layer to form a coating film.

The alignment film is easily coated with the composition for forming a light absorption anisotropic layer by using the composition for forming a light absorption anisotropic layer which contains the above-described solvent or using a liquid-like material such as a melt obtained by heating the composition for forming a light absorption anisotropic layer.

Examples of the coating method using the composition for forming a light absorption anisotropic layer include known methods such as a roll coating method, a gravure printing method, a spin coating method, a wire bar coating method, an extrusion coating method, a direct gravure coating method, a reverse gravure coating method, a die coating method, a spraying method, and an ink jet method.

The aligning step is a step of aligning the liquid crystal component (particularly, the dichroic substance) contained in the coating film. In the aligning step, the dichroic substance is considered to be aligned along the liquid crystal compound aligned by the alignment film.

The aligning step may have a drying treatment. By the drying treatment, components such as a solvent can be removed from the coating film. The drying treatment may be performed by a method of allowing the coating film to stand at room temperature for a predetermined time (for example, natural drying) or a method of heating the coating film and/or blowing air to the coating film.

It is preferable that the alignment step includes a heat treatment. Therefore, the dichroic substance contained in the coating film is further aligned, and the alignment degree of the dichroic substance is further increased.

From the viewpoint of production suitability and the like, the heating treatment is preferably performed at 10° C. to 250° C., and more preferably 25° C. to 190° C. In addition, the heating time is preferably 1 to 300 seconds and more preferably 1 to 60 seconds.

The alignment step may include a cooling treatment performed after the heat treatment. The cooling treatment is a treatment of cooling the coating film after heating to about room temperature (20° C. to 25° C.). Therefore, the alignment of the dichroic substance contained in the coating film is further fixed, and the alignment degree of the dichroic substance is further increased. The cooling means is not particularly limited and can be performed according to a known method.

The light absorption anisotropic layer can be obtained by performing the above-described steps.

The present production method may have a step of curing the light absorption anisotropic layer after the aligning step (hereinafter, also referred to as “curing step”).

For example, the curing step is performed by heating and/or light irradiation (exposure). Among these, light irradiation is preferably performed to conduct the curing step.

Various light sources such as infrared rays, visible light, and ultraviolet rays can be used as a light source for curing, but ultraviolet rays are preferable. In addition, in the curing, ultraviolet rays may be applied while heating is performed. Otherwise, ultraviolet rays may be applied via a filter which transmits only a component with a specific wavelength.

In addition, exposure may be performed under a nitrogen atmosphere. In a case where curing of the light absorption anisotropic layer proceeds by radical polymerization, inhibition of the polymerization by oxygen is reduced, and thus the exposure is preferably performed under a nitrogen atmosphere.

### [Protective Layer]

A protective layer is preferably disposed adjacent to the liquid crystal layer included in the optical film according to the embodiment of the present invention. Here, the protective layer is also referred to as a gas-shielding layer (oxygen-shielding layer) and has a function of protecting the polarizer of the present invention from gas such as oxygen in the atmosphere, the moisture, or the compound contained in an adjacent layer.

For the oxygen-shielding layer, for example, the description in paragraphs [0014] to [0054] of JP2014-159124A, paragraphs [0042] to [0075] of JP2017-121721A, paragraphs [0045] to [0054] of JP2017-115076A, paragraphs [0010] to [0061] of JP2012-213938A, paragraphs [0021] to [0031] of JP2005-169994A, and paragraphs [0122] to [0132] of WO2020/045216A can be referred to.

In addition, from the viewpoint of suppressing internal reflection, the protective layer also preferably contains an additive for adjusting the refractive index to reduce the difference in refractive index from the liquid crystal layer. As the preferred additives, the descriptions in paragraphs [0110] and [0112] of WO2020/045216A can be referred to.

### [Polarizing Plate]

A polarizing plate according to an embodiment of the present invention is a polarizing plate having the above-described optical film according to the embodiment of the present invention.

Here, in a case where the liquid crystal layer included in the optical film according to the embodiment of the present invention is not a light absorption anisotropic layer, the polarizing plate according to the embodiment of the present invention includes a polarizer which will be described later.

The polarizing plate of the embodiment of the present invention may have another optical film, a protective film which will be described later, or another functional layer, in addition to the optical film of the embodiment of the present invention. The function of the functional layer is not particularly limited, and may be, for example, a layer having functions of a stress relaxing layer, a planarizing layer, an antireflection layer, a refractive index adjusting layer, and an ultraviolet absorbing layer.

The protective film may be used on both sides of the polarizer, or may be used on only one side of the polarizer.

In addition, in a case where the protective film is provided on the same side as the optical film of the embodiment of the present invention, it may be arranged between the polarizer and the optical film, or on the side of the optical film opposite to the polarizer, or the like, via a pressure sensitive adhesive or an adhesive.

In a case where the above-described liquid crystal layer is a V/4 plate (positive A plate), the polarizing plate can be used as a circularly polarizing plate.

### [Polarizer]

The polarizer is not particularly limited as long as it is a member functioning to convert light into specific linearly polarized light. An absorption-type polarizer or a reflection-type polarizer which has been known can be used.

An iodine-based polarizer, a dye-based polarizer using a dichroic dye, a polyene-based polarizer, or the like is used as the absorptive type polarizer. The iodine-based polarizer and the dye-based polarizer are classified into a coating type polarizer and a stretching type polarizer, any of which can be applied, but a polarizer which is prepared by allowing polyvinyl alcohol to adsorb iodine or a dichroic dye and performing stretching is preferable.

In addition, examples of a method of obtaining a polarizer by carrying out stretching and dying in a state of a laminated film in which a polyvinyl alcohol layer is formed on a base material include the methods disclosed in JP5048120B, JP5143918B, JP4691205B, JP4751481B, and JP4751486B, and known technologies relating to these polarizers can also be preferably used.

Examples of the coating type polarizer include those in WO2018/124198A, WO2018/186503A, WO2019/132020A, WO2019/132018A, WO2019/189345A, JP2019-197168A, JP2019-194685A, and JP2019-139222A, and known techniques relating to these polarizers can also be preferably used.

A polarizer in which thin films having different birefringence are laminated, a wire grid-type polarizer, a polarizer having a combination of a cholesteric liquid crystal having a selective reflection range, a ¼ wavelength plate, and the like is used as the reflective type polarizer.

Among these, from the viewpoint of more excellent adhesiveness, a polarizer including a polyvinyl alcohol-based resin (a polymer including —CH₂—CHOH— as a repeating unit, in particular, at least one selected from the group consisting of a polyvinyl alcohol and an ethylene-vinyl alcohol copolymer) is preferable.

In addition, from the viewpoint of imparting crack resistance, the polarizer may have a depolarization unit formed along the opposite end edges. Examples of the depolarization unit include JP2014-240970A.

In addition, the polarizer may have non-polarizing parts arranged at predetermined intervals in the long-length direction and/or the width direction. The non-polarizing part is a decolorized part which is partially decolorized. The arrangement pattern of the non-polarizing parts can be appropriately set according to a purpose. For example, the non-polarizing parts are arranged at a position corresponding to a camera unit of an image display device in a case where a polarizer is cut (cut, punched, or the like) to a predetermined size in order to be attached to the image display device in a predetermined size. Examples of the arrangement pattern of the non-polarizing parts include those in JP2016-27392A.

A thickness of the polarizer is not particularly limited, but is preferably 3 to 60 m, more preferably 3 to 30 m, and still more preferably 3 to 10 m.

### [Protective Film]

A material for the protective film is not particularly limited, and examples thereof include a polyacrylic resin film such as a cellulose acylate film (for example, a cellulose triacetate film, a cellulose diacetate film, a cellulose acetate butyrate film, and a cellulose acetate propionate film), and a polymethyl methacrylate, polyolefins such as polyethylene and polypropylene, polyester-based resin films such as polyethylene terephthalate and polyethylene naphthalate, a polyether sulfone film, a polyurethane-based resin film, a polyester film, a polycarbonate film, a polysulfone film, a polyether film, a polymethylpentene film, a polyether ketone film, a (meth)acrylonitrile film, a polyolefin, a polymer with an alicyclic structure (norbornene-based resin (ARTON: product name, manufactured by JSR Corporation) and an amorphous polyolefin (ZEONEX: product name, manufactured by Nippon Zeon Co., Ltd.)). Among these, the cellulose acylate film is preferable.

The optical characteristics of the protective film are not particularly limited, but in a case where the protective film is provided on the same side as the optical film of the embodiment of the present invention, it is preferable to satisfy the following expression.

$$0 nm \leq Re ( 550 ) \leq 10 nm \\ - 40 nm \leq Rth ( 550 ) \leq 40 nm$$

### [Image Display Device]

An image display device according to the embodiment of the present invention is an image display device including the optical film according to the embodiment of the present invention or the polarizing plate according to the embodiment of the present invention.

A display element used in the image display device is not particularly limited, and examples thereof include a liquid crystal cell, an organic electroluminescent (hereinafter simply referred to as “electroluminescence (EL)”) display panel, and a plasma display panel. Among those, the liquid crystal cell and the organic EL display panel are preferable, and the liquid crystal cell is more preferable.

That is, as the image display device, a liquid crystal display device using a liquid crystal cell as a display element or an organic EL display device using an organic EL display panel as a display element is preferable, and the liquid crystal display device is more preferable.

The image display device according to the embodiment of the present invention is preferably a flexible panel.

In addition, the image display device according to the embodiment of the present invention include, as described above, the aspect including the polarizing plate according to the embodiment of the present invention, and the image display device may be a flexible panel including the polarizing plate according to the embodiment of the present invention.

### [Liquid Crystal Display Device]

A liquid crystal display device which is an example of the image display device is a liquid crystal display device having the above-mentioned polarizing plate and a liquid crystal cell.

It is preferable that the above-mentioned polarizing plate is used as the polarizing plate of the front side, and it is more preferable that the above-mentioned polarizing plate is used as the polarizing plates on the front and rear sides, among the polarizing plates provided on both sides of the liquid crystal cell.

Hereinafter, the liquid crystal cell constituting the liquid crystal display device will be described in detail.

### <Liquid Crystal Cell>

The liquid crystal cell used in the liquid crystal display device is in a vertical alignment (VA) mode, an optically compensated bend (OCB) mode, an in-plane-switching (IPS) mode, a fringe-field-switching (FFS) mode, or a twisted nematic (TN) mode is preferred, but is not limited to these.

In a TN mode liquid crystal cell, rod-like liquid crystal molecules are substantially horizontally aligned and are twist-aligned at 600 to 120° during no voltage application thereto. The TN mode liquid crystal cell is most often used in a color TFT liquid crystal display device and is described in numerous documents.

In a VA mode liquid crystal cell, rod-like liquid crystal molecules are substantially vertically aligned during no voltage application thereto. Examples of the VA mode liquid crystal cell include (1) a VA mode liquid crystal cell in the narrow sense of the word, in which rod-like liquid crystal molecules are substantially vertically aligned during no voltage application thereto, but are substantially horizontally aligned during voltage application thereto (described in JP1990-176625A (JP-H02-176625A)), (2) an MVA mode liquid crystal cell in which the VA mode is multi-domained for viewing angle enlargement (described in SID97, Digest of tech. Papers (preprint), 28 (1997) 845), (3) a liquid crystal cell in a mode (n-ASM mode) in which rod-like liquid crystal molecules are substantially vertically aligned during no voltage application thereto and are multi-domain-aligned during voltage application thereto (described in Seminar of Liquid Crystals of Japan, Papers (preprint), 58-59 (1998)), and (4) a survival mode liquid crystal cell (announced in LCD International 98). In addition, the liquid crystal cell in the VA mode may be any of a patterned vertical alignment (PVA) type, an optical alignment type, and a polymer-sustained alignment (PSA) type. Details of these modes are specifically described in JP2006-215326A and JP2008-538819A.

In an IPS mode liquid crystal cell, rod-like liquid crystal molecules are aligned substantially parallel with respect to a substrate, and application of an electric field parallel to the substrate surface causes the liquid crystal molecules to respond planarly. The IPS mode displays black in a state where no electric field is applied and a pair of upper and lower polarizing plates have absorption axes which are orthogonal to each other. A method of improving the view angle by reducing light leakage during black display in an oblique direction using an optical compensation sheet is disclosed in JP1998-54982A (JP-H10-54982A), JP1999-202323A (JP-H11-202323A), JP1997-292522A (JP-H09-292522A), JP1999-133408A (JP-H11-133408A), JP1999-305217A (JP-H11-305217A), JP1998-307291A (JP-H10-307291A), and the like.

### [Organic EL Display Device]

Examples of the organic EL display device which is an example of the image display device include an aspect which includes, from the visible side, a polarizer, a V/4 plate (a positive A plate) consisting of the above-mentioned liquid crystal cured layer, and an organic EL display panel in this order.

In addition, the organic EL display panel is a display panel constituted with an organic EL element in which an organic light emitting layer (organic electroluminescent layer) is sandwiched between electrodes (between a cathode and an anode). The configuration of the organic EL display panel is not particularly limited but a known configuration is adopted.

### EXAMPLES

Hereinafter, the present invention will be described in more detail based on Examples. The materials, amounts used, proportions, treatment details, treatment procedures, and the like shown in the following examples can be appropriately changed as long as not departing from the gist of the present invention. Accordingly, the scope of the present invention should not be construed as being limited to Examples shown below.

### Example 1

### [Preparation of Base Material]

The following composition was put into a mixing tank, stirred, and further heated at 90° C. for 10 minutes. Thereafter, the obtained composition was filtered through filter paper having an average pore size of 34 m and a sintered metal filter having an average pore size of m, thereby preparing a dope. The concentration of solid contents of the dope was 23.5% by mass, the addition amount of the plasticizer was the ratio to the cellulose acylate, and the solvent of the dope was methylene chloride/methanol/butanol=81/18/1 (mass ratio).

Cellulose acylate dope

| | | |
|---|---|---|
| Cellulose acylate | 100 | parts by mass |
| (acetyl substitution degree of 2.86, viscosity | | |
| average polymerization degree of 310) | | |
| Sugar ester compound 1 (Formula (S4)) | 6.0 | parts by mass |
| Sugar ester compound 2 (Formula (S5)) | 2.0 | parts by mass |
| Silica particle dispersion liquid | 0.1 | parts by mass |
| (AEROSIL R972, manufactured by Nippon | | |
| Aerosil Co., Ltd.) | | |
| Solvent (methylene chloride/methanol/ | 351.9 | parts by mass |
| butanol) | | |

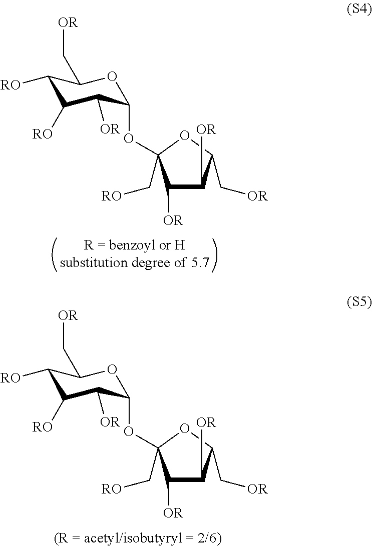

The prepared above was cast using a drum film-forming machine. The dope was cast from a die such that the dope was in contact with the metal support cooled to 0° C., and the obtained web (film) was peeled off a drum. The drum was made of stainless steel (SUS).

The web (film) obtained by casting was peeled off from the drum and dried in a tenter device for 20 minutes using a tenter device such that both ends of the web were clipped with clips and transported at 30° C. to 40° C. during film transport. Subsequently, the web was post-dried by zone heating while being transported using a roll. The obtained web was subjected to knurling and wound up to obtain a cellulose acylate film A1.

The film thickness of the obtained cellulose acylate film A1 was 60 m, the in-plane retardation Re (550) at a wavelength of 550 nm was 1 nm, and the retardation Rth (550) at a wavelength of 550 nm in the thickness direction was 35 nm.

### [Formation of Photo-Alignment Film B1]

The above-described cellulose acylate film A1 was continuously coated with a composition B1 for forming a photo-alignment film described below with a wire bar. The support on which the coating film had been formed was dried with hot air at 140° C. for 120 seconds, and the coating film was irradiated with polarized ultraviolet rays (10 mJ/cm², using an ultra-high pressure mercury lamp) to form a photo-alignment film B1, thereby obtaining a triacetyl cellulose (TAC) film with the photo-alignment film. A film thickness of the photo-alignment film B1 was 1.5 m.

Formulation of composition B1 for forming photo-alignment film

| | | |
|---|---|---|
| The following photo-alignment compound | 100.00 | parts by mass |
| PA-1 | | |
| EPICLON N-695 | 55.74 | parts by mass |
| (manufactured by DIC Corporation) | | |
| jER YX7400 (manufactured by Mitsubishi | 18.75 | parts by mass |
| Chemical Corporation) | | |
| The following polymerizable macromolecule | 8.01 | parts by mass |
| PA-2 | | |
| The following thermal cationic | 16.75 | parts by mass |
| polymerization initiator PAG-1 | | |
| The following stabilizer DIPEA | 1.06 | parts by mass |
| Butyl acetate | 1230.49 | parts by mass |

Photo-alignment compound PA-1 (weight-average molecular weight: 32,000)

(in the formulae, the numerical value described in each repeating unit represents a content (% by mass) of each repeating units with respect to all repeating units)

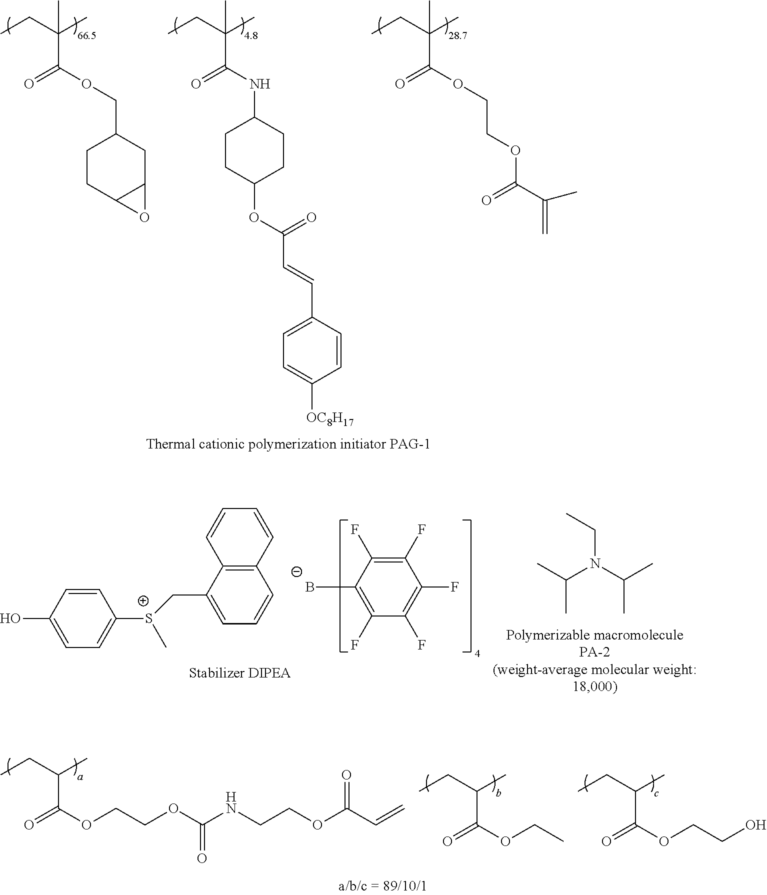

### [Formation of Light Absorption Anisotropic Layer C1]

A coating film was formed by continuously coating the obtained photo-alignment film B1 with a composition C1 for forming a light absorption anisotropic layer, having the following formulation, with a wire bar.

Next, the coating film was heated at 140° C. for 15 seconds, subjected to a heat treatment at 80° C. for 5 seconds, and cooled to room temperature (23° C.). Next, the coating film was heated at 75° C. for 60 seconds, and was cooled to room temperature again.

Thereafter, the light absorption anisotropic layer C1 (polarizer) (thickness: 1.8 m) was formed on the photo-alignment film B1 by performing irradiation with the Light emitting diode (LED) lamp (central wavelength of 365 nm) under irradiation conditions of 300 mJ.

In a case where a transmittance of the light absorption anisotropic layer C1 in a wavelength range of 280 to 780 nm was measured with a spectrophotometer, and the average transmittance of visible light was 42%.

The absorption axis of the light absorption anisotropic layer C1 was in the plane of the light absorption anisotropic layer C1, and was orthogonal to a width direction of the cellulose acylate film A1.

Formulation of composition C1 for forming light absorption
anisotropic layer

| | | |
|---|---|---|
| The following first dichroic substance Dye-C1 | 0.65 | parts by mass |
| The following second dichroic substance | 0.15 | parts by mass |
| Dye-M1 | | |
| The following third dichroic substance Dye-Y1 | 0.52 | parts by mass |
| The following liquid crystal compound L-1 | 2.69 | parts by mass |
| The following liquid crystal compound L-2 | 1.15 | parts by mass |
| The following adhesion improver A-1 | 0.17 | parts by mass |
| Polymerization initiator IRGACURE | 0.17 | parts by mass |
| OXE-02 (manufactured by BASF SE) | | |
| The following surfactant F-1 | 0.013 | parts by mass |
| Cyclopentanone | 92.14 | parts by mass |
| Benzyl alcohol | 2.36 | parts by mass |

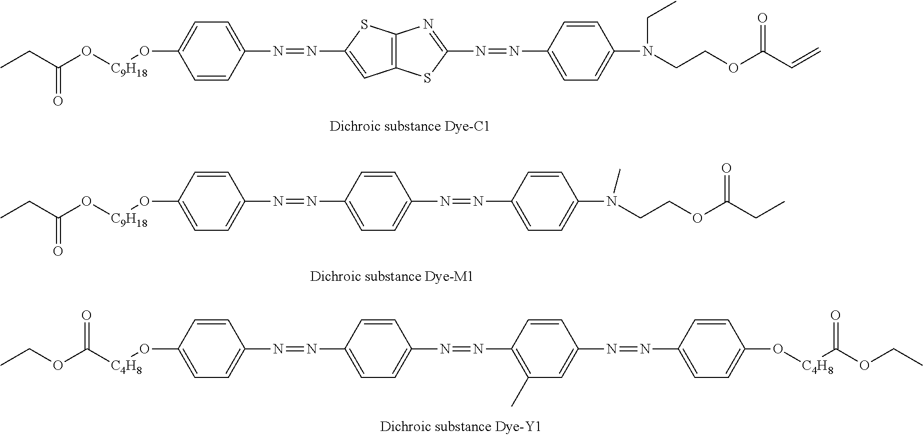

Liquid crystal compound L-1 (weight-average molecular weight: 18,000)

(In the following formula, the numerical values (“59”, “15”, “26”) described in each repeating unit represent the content (% by mass) of each repeating unit with respect to all the repeating units.)

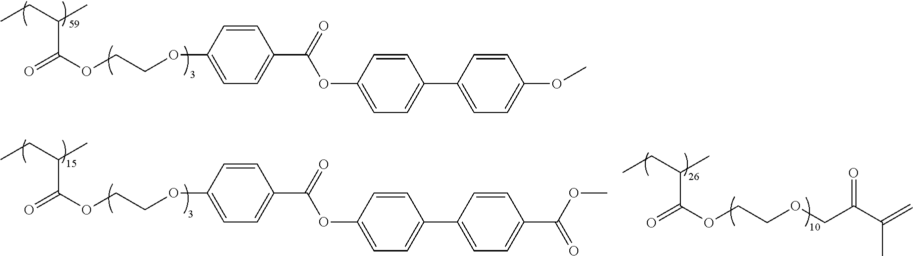

Liquid crystal compound L-2 (mixture of the following liquid crystal compounds (RA), (RB), and (RC) at a ratio of 84:14:2 (mass ratio))

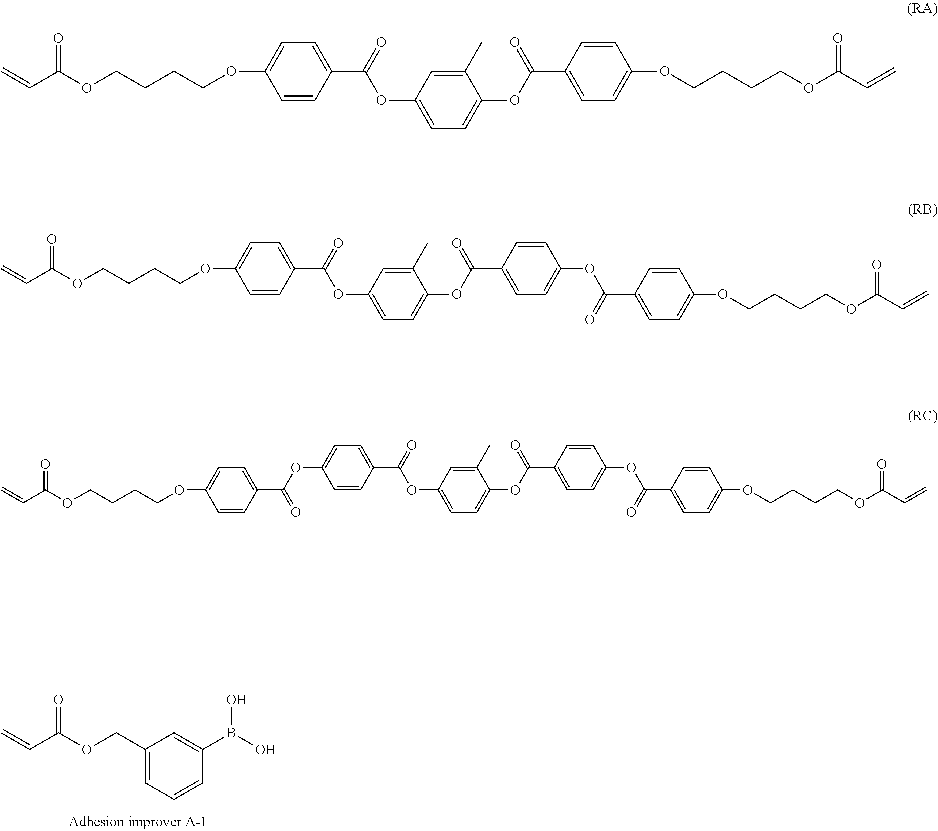

Surfactant F-1 (weight-average molecular weight: 15,000)

(In the formulae, the numerical values described in each repeating unit represent the content (% by mass) of each repeating unit with respect to all the repeating units. In addition, Ac represents —C(O)CH₃.)

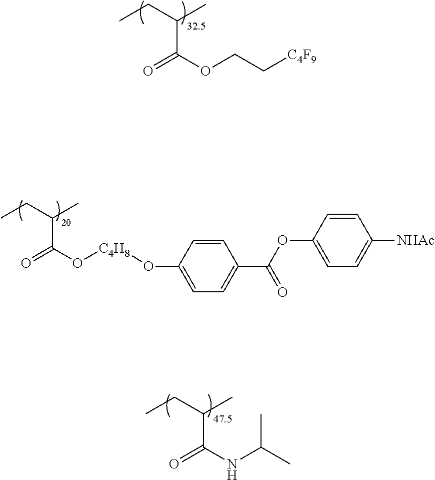

### [Formation of Protective Layer D1]

The light absorption anisotropic layer C1 was continuously coated with a coating liquid D1 having the following formulation, with a wire bar.

Thereafter, the coating liquid D1 was dried with hot air at 80° C. for 5 minutes, and irradiated with an LED lamp (central wavelength of 365 nm) under irradiation conditions of 300 mJ, thereby obtaining a laminate formed of a protective layer D2 consisting of a polyvinyl alcohol (PVA) having a thickness of 0.6 m, that is, an optical film CP1 including the cellulose acylate film A1 (base material), the photo-alignment film B1, the light absorption anisotropic layer C1, and the protective layer D1, which were adjacent to each other in this order.

Formulation of coating liquid D1 for forming protective layer

| | | |
|---|---|---|
| The following modified polyvinyl alcohol | 3.31 | parts by mass |
| Initiator IRGACURE 2959 | 0.17 | parts by mass |
| (manufactured by BASF SE) | | |
| Glutaraldehyde | 0.07 | parts by mass |
| Pyridinium paratoluene sulfonate | 0.05 | parts by mass |
| The following surfactant F-9 | 0.0018 | parts by mass |
| Water | 74.0 | parts by mass |
| Ethanol | 22.4 | parts by mass |

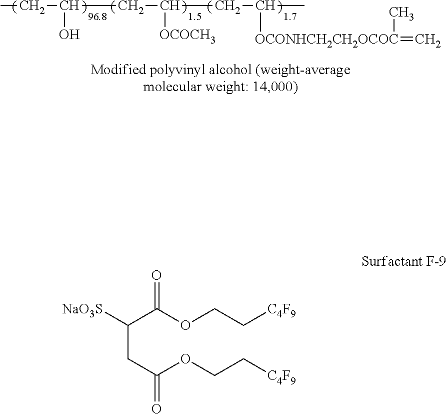

### Examples 2 to 14 and Comparative Examples 1 to 3

An optical film was prepared in the same manner as in Example 1, except that various conditions such as the type of the polymerizable macromolecule and the ratio (mass proportion with respect to the total solid content) were changed as shown in Table 3 below.

In a case where the formulation of the composition for forming a photo-alignment film was changed with respect to Example 1, the total amount of non-volatile components was made constant by simultaneously adjusting the amount of EPICLON N-695.

In addition, the structures of the polymerizable macromolecules PA-3, PA-4, and PA-5 used in Comparative Example 3, Example 13, and Example 14 are as follows.

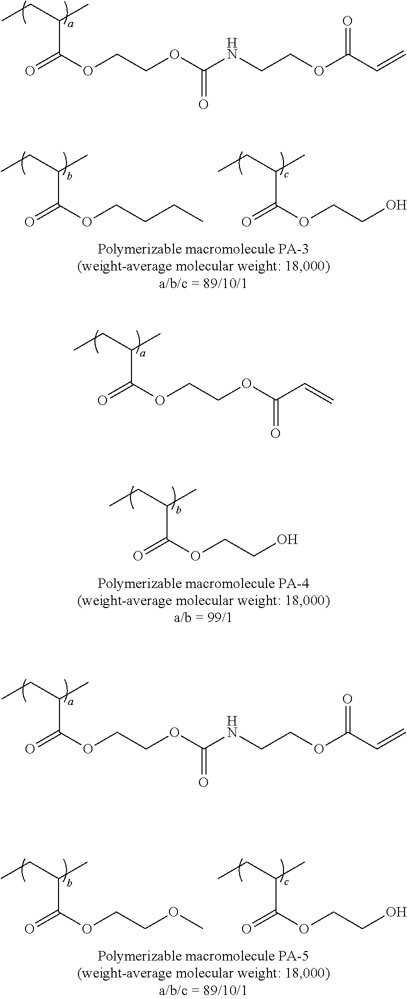

### Example 15

### [Formation of Photo-Alignment Film B2]

The above-described cellulose acylate film A1 was continuously coated with a composition B2 for forming a photo-alignment film described below with a wire bar. The support on which the coating film had been formed was dried with hot air at 60° C. for 120 seconds, and the coating film was irradiated with polarized ultraviolet rays (100 mJ/cm², using an ultra-high pressure mercury lamp) to form a photo-alignment film B2, thereby obtaining a triacetyl cellulose (TAC) film with the photo-alignment film. A film thickness of the photo-alignment film B2 was 0.5 m.

Formulation of composition B2 for forming photo-alignment film

| | | |
|---|---|---|
| The following photo-alignment compound | 100.00 | parts by mass |
| PA-6 | | |
| The following polymerizable macromolecule | 4.30 | parts by mass |
| PA-2 | | |
| Polymerization initiator IRGACURE | 3.23 | parts by mass |
| OXE-02 (manufactured by BASF SE) | | |
| Cyclopentanone | 2150.54 | parts by mass |

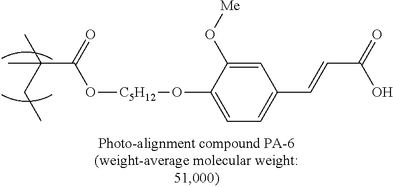

### [Formation of Light Absorption Anisotropic Layer C2]

A coating film was formed by continuously coating the obtained photo-alignment film B2 with a composition C2 for forming a light absorption anisotropic layer, having the following formulation, with a wire bar. Next, the coating film was heated at 120° C. for 60 seconds, and was cooled to room temperature. Thereafter, the coating film was irradiated with an LED lamp (central wavelength: 365 nm) under an irradiation condition of 300 mJ to form the light absorption anisotropic layer C2 (polarizer) (thickness: 1.7 m) on the photo-alignment film B2, thereby obtaining an optical film CP2 including the cellulose acylate film A1 (base material), the photo-alignment film B2, and the light absorption anisotropic layer C2, which were adjacent to each other in this order.

Formulation of composition C2 for forming light absorption
anisotropic layer

| | | |
|---|---|---|
| The following fourth dichroic substance Dye 4 | 0.08 | parts by mass |
| The following fifth dichroic substance Dye 5 | 0.26 | parts by mass |
| The following sixth dichroic substance Dye 6 | 0.22 | parts by mass |
| The following seventh dichroic substance Dye 7 | 0.18 | parts by mass |
| The following liquid crystal compound M-1 | 10.00 | parts by mass |
| Polymerization initiator | 0.50 | parts by mass |
| IRGACURE 369 (manufactured by BASF SE) | | |
| BYK-361N (manufactured by BYK Japan KK) | 0.09 | parts by mass |
| Cyclopentanone | 92.50 | parts by mass |

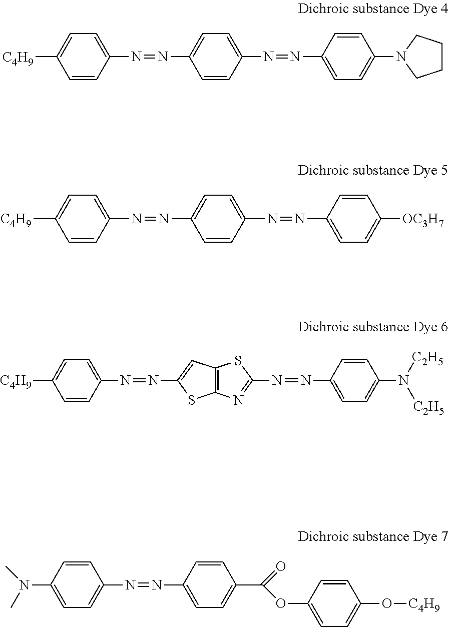

Liquid crystal compound M-1 (mixing at the following compound A/the following compound B=75/25)

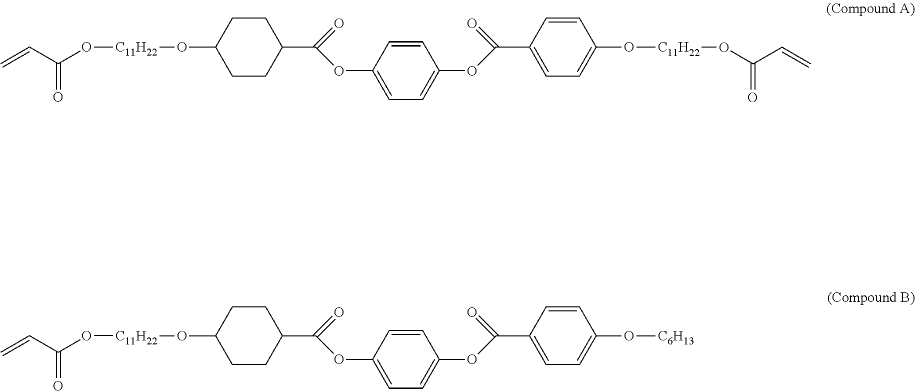

### Example 16

The photo-alignment film used in Example 2 was referred to as a photo-alignment film B3.

An optical film CP3 including the cellulose acylate film A1 (base material), the photo-alignment film B3, and the light absorption anisotropic layer C2 which were adjacent to each other in this order was obtained.

### Example 17

### [Formation of Photo-Alignment Film B4]

The above-described cellulose acylate film A1 was continuously coated with a composition B4 for forming a photo-alignment film described below with a wire bar. The support on which a coating film was formed was dried with hot air at 140° C. for 120 seconds, and the coating film was irradiated with polarized ultraviolet rays (10 mJ/cm², using an ultra-high pressure mercury lamp) to form a photo-alignment film B4, thereby obtaining a triacetyl cellulose (TAC) film with a photo-alignment film. A film thickness of the photo-alignment film B4 was 1.5 m.

Formulation of composition B4 for forming photo-alignment film

| | | |
|---|---|---|
| The above-described photo-alignment | 100.00 | parts by mass |
| compound PA-1 | | |
| The above-described polymerizable | 4.76 | parts by mass |
| macromolecule PA-2 | | |
| The above-described thermal cationic | 9.94 | parts by mass |
| polymerization initiator PAG-1 | | |
| The above-described stabilizer DIPEA | 0.63 | parts by mass |
| Polymerization initiator IRGACURE | 3.57 | parts by mass |
| OXE-02 (manufactured by BASF SE) | | |
| Butyl acetate | 730.36 | parts by mass |

### [Formation of Light Absorption Anisotropic Layer C3]

A coating film was formed by continuously coating the obtained photo-alignment film B4 with a composition C3 for forming a light absorption anisotropic layer, having the following formulation, with a wire bar.

Next, the coating film was heated at 140° C. for 15 seconds, subjected to a heat treatment at 80° C. for 5 seconds, and cooled to room temperature (23° C.). Next, the coating film was heated at 75° C. for 60 seconds, and was cooled to room temperature again. The light absorption anisotropic layer C3 (polarizer) (thickness: 3.5 m) was formed on the photo-alignment film B4 to obtain an optical film CP4 including the cellulose acylate film A1 (base material), the photo-alignment film B4, and the light absorption anisotropic layer C3 which are adjacent to each other in this order.

In a case where a transmittance of the light absorption anisotropic layer C1 in a wavelength range of 280 to 780 nm was measured with a spectrophotometer, and the average transmittance of visible light was 75%.

The absorption axis of the light absorption anisotropic layer C3 was out of the plane of the light absorption anisotropic layer C3.

Formulation of composition C3 for forming light absorption
anisotropic layer

| | | |
|---|---|---|
| The above-described first dichroic substance | 1.13 | parts by mass |
| Dye-C1 | | |
| The above-described second dichroic substance | 0.17 | parts by mass |
| Dye-M1 | | |
| The above-described third dichroic substance | 0.63 | parts by mass |
| Dye-Y1 | | |
| The above-described liquid crystal compound | 6.60 | parts by mass |
| L-1 | | |
| The above-described liquid crystal compound | 1.58 | parts by mass |
| L-2 | | |
| Polymerization initiator IRGACURE | 0.16 | parts by mass |
| OXE-02 (manufactured by BASF SE) | | |
| The following alignment agent E-1 | 0.13 | parts by mass |
| The following alignment agent E-2 | 0.13 | parts by mass |
| The following surfactant F-2 | 0.007 | parts by mass |
| Cyclopentanone | 80.53 | parts by mass |
| Benzyl alcohol | 8.95 | parts by mass |

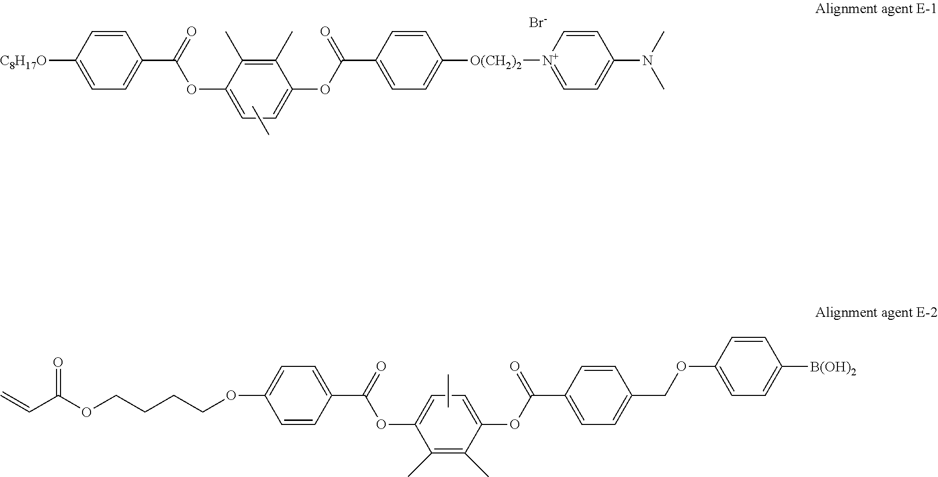

Surfactant F-2 (weight-average molecular weight: 12,000) (in the following formula, the numerical values (“80”, “10”, “10”) described in each repeating unit represent the content (% by mass) of each repeating unit with respect to all the repeating units.)

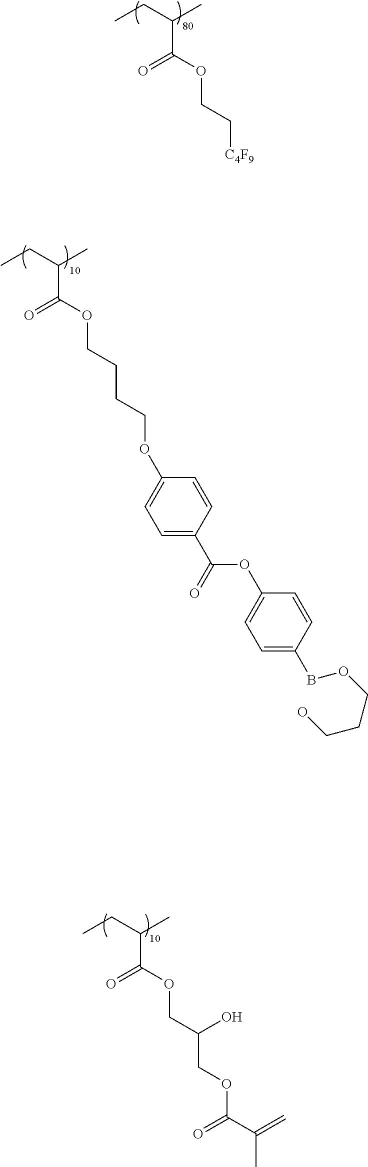

### Example 18

### [Formation of Light Absorption Anisotropic Layer C4]

The composition C4 for forming a light absorption anisotropic layer having the following formulation was continuously applied onto the photo-alignment film B1 obtained by the same method as in Example 1, with a wire bar, to form a coating film.

Next, the coating film was heated at 130° C. for 15 seconds, and the coating film was cooled to room temperature (23° C.). Next, the coating film was heated at 75° C. for 10 seconds, and was cooled to room temperature again.

Thereafter, the light absorption anisotropic layer C4 (polarizer) (thickness: 1.8 m) was formed on the photo-alignment film B1 by performing irradiation with an LED lamp (central wavelength of 365 nm) under an irradiation condition of 300 mJ, thereby preparing an optical film.

In a case where a transmittance of the light absorption anisotropic layer C4 in a wavelength range of 380 to 780 nm was measured with a spectrophotometer, and the average transmittance of visible light was 42%.

The absorption axis of the light absorption anisotropic layer C4 was in the plane of the light absorption anisotropic layer C4, and was orthogonal to a width direction of the cellulose acylate film A1.

Formulation of composition C4 for forming light absorption
anisotropic layer

| | | |
|---|---|---|
| The above-described first dichroic substance | 0.19 | parts by mass |
| Dye-C1 | | |
| The following second dichroic substance | 0.58 | parts by mass |
| Dye-C2 | | |
| The above-described second dichroic | 0.19 | parts by mass |
| substance Dye-M1 | | |
| The following third dichroic substance | 0.03 | parts by mass |
| Dye-Y2 | | |
| The above-described liquid crystal compound | 3.27 | parts by mass |
| L-1 | | |
| The above-described liquid crystal compound | 1.40 | parts by mass |
| L-2 | | |
| The above-described adhesion improver A-1 | 0.06 | parts by mass |
| Polymerization initiator IRGACURE | 0.18 | parts by mass |
| OXE-02(manufactured by BASF SE) | | |
| The following surfactant F-2 | 0.006 | parts by mass |
| Cyclopentanone | 91.75 | parts by mass |
| Benzyl alcohol | 2.35 | parts by mass |

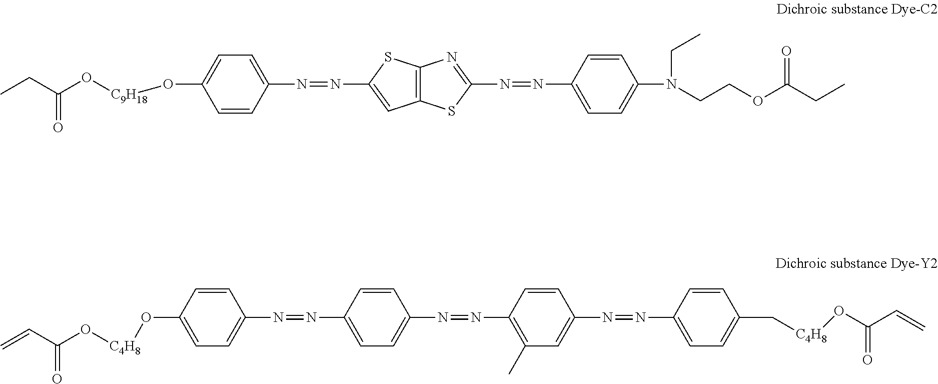

Surfactant F-2 (weight-average molecular weight: 15,000)

(in the formulae, the numerical value described in each repeating unit represents a content (% by mass) of each repeating unit with respect to all repeating units)

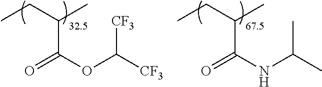

### Example 19

### [Formation of Light Absorption Anisotropic Layer C5]

The composition C5 for forming a light absorption anisotropic layer having the following formulation was continuously applied onto the photo-alignment film B1 obtained by the same method as in Example 1, with a wire bar, to form a coating film.

Next, the coating film was heated at 130° C. for 15 seconds, and the coating film was cooled to room temperature (23° C.). Next, the coating film was heated at 75° C. for 10 seconds, and was cooled to room temperature again.

Thereafter, the light absorption anisotropic layer C5 (polarizer) (thickness: 1.8 m) was formed on the photo-alignment film B1 by performing irradiation with an LED lamp (central wavelength of 365 nm) under an irradiation condition of 300 mJ, thereby preparing an optical film.

In a case where a transmittance of the light absorption anisotropic layer C5 in a wavelength range of 380 to 780 nm was measured with a spectrophotometer, and the average transmittance of visible light was 42%.

The absorption axis of the light absorption anisotropic layer C5 was in the plane of the light absorption anisotropic layer C5, and was orthogonal to a width direction of the cellulose acylate film A1.

Formulation of composition C5 for forming light absorption
anisotropic layer

| | | |
|---|---|---|
| The above-described first dichroic substance | 0.19 | parts by mass |
| Dye-C1 | | |
| The above-described second dichroic substance | 0.58 | parts by mass |
| Dye-C2 | | |
| The above-described second dichroic substance | 0.19 | parts by mass |
| Dye-M1 | | |
| The above-described third dichroic substance | 0.03 | parts by mass |
| Dye-Y2 | | |
| The above-described liquid crystal compound | 3.27 | parts by mass |
| L-1 | | |
| The following liquid crystal compound L-3 | 1.40 | parts by mass |
| The above-described adhesion improver A-1 | 0.06 | parts by mass |
| Polymerization initiator IRGACURE OXE-02 | 0.18 | parts by mass |
| (manufactured by BASF SE) | | |
| The above-described surfactant F-2 | 0.006 | parts by mass |
| Cyclopentanone | 91.75 | parts by mass |
| Benzyl alcohol | 2.35 | parts by mass |

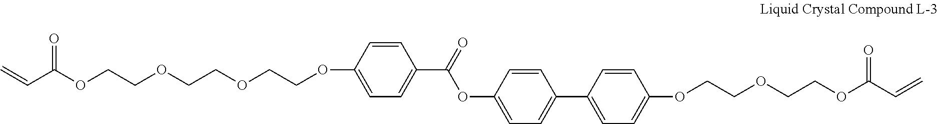 [SMILES: C=CC(=O)OCCOCCOCCOc1ccc(C(=O)Oc2ccc(-c3ccc(OCCOCCOC(=O)C=C)cc3)cc2)cc1]

### Example 20

### [Formation of Light Absorption Anisotropic Layer C6]

The composition C6 for forming a light absorption anisotropic layer having the following formulation was continuously applied onto the photo-alignment film B1 obtained by the same method as in Example 1, with a wire bar, to form a coating film.

Next, the coating film was heated at 130° C. for 15 seconds, and the coating film was cooled to room temperature (23° C.). Next, the coating film was heated at 75° C. for 10 seconds, and was cooled to room temperature again.

Thereafter, the light absorption anisotropic layer C6 (polarizer) (thickness: 1.8 m) was formed on the photo-alignment film B1 by performing irradiation with an LED lamp (central wavelength of 365 nm) under an irradiation condition of 300 mJ, thereby preparing an optical film.

In a case where a transmittance of the light absorption anisotropic layer C6 in a wavelength range of 380 to 780 nm was measured with a spectrophotometer, and the average transmittance of visible light was 42%.

The absorption axis of the light absorption anisotropic layer C6 was in the plane of the light absorption anisotropic layer C6, and was orthogonal to a width direction of the cellulose acylate film A1.

Formulation of composition C6 for forming light absorption
anisotropic layer

| | | |
|---|---|---|
| The above-described first dichroic substance | 0.19 | parts by mass |
| Dye-C1 | | |
| The above-described second dichroic substance | 0.58 | parts by mass |
| Dye-C2 | | |
| The above-described second dichroic substance | 0.19 | parts by mass |
| Dye-M1 | | |
| The above-described third dichroic substance | 0.03 | parts by mass |
| Dye-Y2 | | |
| The above-described liquid crystal compound | 3.27 | parts by mass |
| L-1 | | |
| The above-described liquid crystal compound | 1.40 | parts by mass |
| L-3 | | |
| The above-described adhesion improver A-1 | 0.06 | parts by mass |
| Polymerization initiator IRGACURE OXE-02 | 0.18 | parts by mass |
| (manufactured by BASF SE) | | |
| The following surfactant F-3 | 0.009 | parts by mass |
| Cyclopentanone | 91.75 | parts by mass |
| Benzyl alcohol | 2.35 | parts by mass |

Surfactant F-3 (weight-average molecular weight: 11,000)

(In the formulae, the numerical values described in each repeating unit represent the content (% by mass) of each repeating unit with respect to all the repeating units. In addition, Ac represents —C(O)CH₃.)

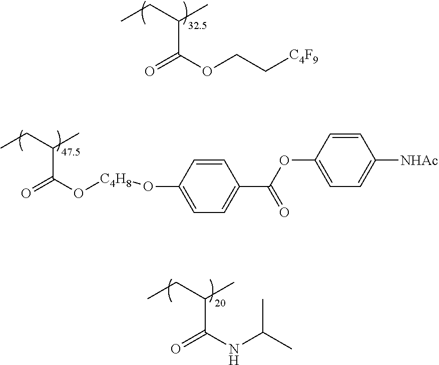

### Example 21

[Formation of long-length polarizing film R1]

The cellulose acylate film A1 was continuously unwound at a rate of 20 m/min, and the above-described composition B1 for forming a photo-alignment film was applied thereto using a slot die coater, followed by drying with hot air at 140° C. for 120 seconds to form a photo-alignment film B1. At this time, a film thickness of the photo-alignment film B1 was 1.5 m. Thereafter, the photo-alignment film B1 was irradiated with polarized UV in a direction of 90° with respect to a longitudinal direction of the film such that the intensity was 8 mJ (with a reference of 313 nm), to impart an alignment regulating force, thereby forming a long-length photo-alignment film.

The composition C4 for forming a light absorption anisotropic layer was applied onto the obtained photo-alignment film B1 using a slot die coater, the coating film was heated at 130° C. for 15 seconds, and the coating film was cooled to room temperature (23° C.). Next, the coating film was heated at 75° C. for 10 seconds, and was cooled to room temperature again. Thereafter, the light absorption anisotropic layer C4 (polarizer) (thickness: 1.8 m) was formed on the photo-alignment film B1 by performing irradiation with an LED lamp (central wavelength of 365 nm) under an irradiation condition of 300 mJ.

In a case where a transmittance of the light absorption anisotropic layer C4 in a wavelength range of 380 to 780 nm was measured with a spectrophotometer, and the average transmittance of visible light was 42%. The absorption axis of the light absorption anisotropic layer C4 was in the plane of the light absorption anisotropic layer C4, and was parallel to a longitudinal direction of the cellulose acylate film A1.

The coating liquid D1 for forming a protective layer was applied onto the obtained light absorption anisotropic layer C4 using a slot die coater, dried with hot air at 80° C. for 5 minutes, and irradiated with an LED lamp (central wavelength of 365 nm) under an irradiation condition of 300 mJ, thereby forming a protective layer D2 consisting of polyvinyl alcohol (PVA) having a thickness of 0.6 m. In this case, the thickness of the protective layer D2 was 0.6 m.

Thereafter, the film was continuously wound up in a roll shape to obtain a long-length polarizing film R1 having an absorption axis in a direction parallel to the longitudinal direction as an optical film.

### Examples 22 and 23

### [Formation of Long-Length Polarizing Films R2 and R3]

Long-length polarizing films R2 and R3 were prepared as optical film by the same method as in Example 21, except that the composition for forming a light absorption anisotropic layer and the film thickness were changed as shown in Table 6 below. The compositions used for forming the light absorption anisotropic layer are shown below.

### [Composition C7 for Forming Light Absorption Anisotropic Layer]

Formulation of composition C7 for forming light absorption
anisotropic layer

| | | |
|---|---|---|
| The above-described first dichroic substance | 0.12 | parts by mass |
| Dye-C1 | | |
| The above-described second dichroic substance | 0.37 | parts by mass |
| Dye-C2 | | |
| The above-described second dichroic substance | 0.12 | parts by mass |
| Dye-M1 | | |
| The above-described third dichroic substance | 0.21 | parts by mass |
| Dye-Y1 | | |
| The above-described liquid crystal compound | 2.77 | parts by mass |
| L-1 | | |
| The above-described liquid crystal compound | 1.19 | parts by mass |
| L-2 | | |
| The above-described adhesion improver A-1 | 0.05 | parts by mass |
| Polymerization initiator IRGACURE OXE-02 | 0.15 | parts by mass |
| (manufactured by BASF SE) | | |
| The above-described surfactant F-2 | 0.005 | parts by mass |
| Cyclopentanone | 92.61 | parts by mass |
| Benzyl alcohol | 2.37 | parts by mass |

[Composition C8 for forming light absorption anisotropic layer]
Formulation of composition C7 for forming light absorption
anisotropic layer

| | | |
|---|---|---|
| The above-described first dichroic substance | 0.12 | parts by mass |
| Dye-C1 | | |
| The above-described second dichroic substance | 0.37 | parts by mass |
| Dye-C2 | | |
| The above-described second dichroic substance | 0.12 | parts by mass |
| Dye-M1 | | |
| The above-described third dichroic substance | 0.02 | parts by mass |
| Dye-Y2 | | |
| The above-described liquid crystal compound | 1.29 | parts by mass |
| L-1 | | |
| The above-described liquid crystal compound | 0.55 | parts by mass |
| L-3 | | |
| The above-described adhesion improver A-1 | 0.04 | parts by mass |
| Polymerization initiator IRGACURE OXE-02 | 0.07 | parts by mass |
| (manufactured by BASF SE) | | |
| The above-described surfactant F-1 | 0.01 | parts by mass |
| Cyclopentanone | 94.97 | parts by mass |
| Benzyl alcohol | 2.44 | parts by mass |

### Example 24

### [Formation of Long-Length Polarizing Film R4]

The cellulose acylate film A1 was continuously unwound at a rate of 20 m/min, and the composition B1 for forming a photo-alignment film was applied thereto using a slot die coater, followed by drying with hot air at 140° C. for 120 seconds to form a photo-alignment film B1. At this time, a film thickness of the photo-alignment film B1 was 1.5 m. Thereafter, the photo-alignment film B1 was irradiated with polarized UV in a direction of 0° with respect to a longitudinal direction of the film such that the intensity was 8 mJ (with a reference of 313 nm), to impart an alignment regulating force, thereby forming a long-length photo-alignment film.

The composition C4 for forming a light absorption anisotropic layer was applied onto the obtained photo-alignment film using a slot die coater, the coating film was heated at 130° C. for 15 seconds, and the coating film was cooled to room temperature (23° C.). Next, the coating film was heated at 75° C. for 10 seconds, and was cooled to room temperature again. Thereafter, the light absorption anisotropic layer C4 (polarizer) (thickness: 1.8 m) was formed on the photo-alignment film B1 by performing irradiation with an LED lamp (central wavelength of 365 nm) under an irradiation condition of 300 mJ. In a case where a transmittance of the light absorption anisotropic layer C4 in a wavelength range of 380 to 780 nm was measured with a spectrophotometer, and the average transmittance of visible light was 42%. The absorption axis of the light absorption anisotropic layer C4 was in the plane of the light absorption anisotropic layer C4, and was perpendicular to a longitudinal direction of the cellulose acylate film A1.

The coating liquid D1 for forming a protective layer was applied onto the obtained light absorption anisotropic layer C4 using a slot die coater, dried with hot air at 80° C. for 5 minutes, and irradiated with an LED lamp (central wavelength of 365 nm) under an irradiation condition of 300 mJ, thereby forming a protective layer D2 consisting of polyvinyl alcohol (PVA) having a thickness of 0.6 m. In this case, the thickness of the protective layer D2 was 0.6 m. Thereafter, the film was continuously wound up in a roll shape to obtain a long-length polarizing film R4 having an absorption axis in a direction perpendicular to the longitudinal direction as an optical film.

### Examples 25 and 26

### [Formation of Long-Length Polarizing Films R5 and R6]

Long-length polarizing films R5 and R6 were prepared as optical film by the same method as in Example 24, except that the composition for forming a light absorption anisotropic layer and the film thickness were changed as shown in Table 6 below.

### [Evaluation]

### [Peeling Force]

Using the obtained optical film, the peeling force of the base material was evaluated.

Specifically, the peeling force in a case where an optical film was cut into 150 mm×25 mm, the surface of the optical film on the side opposite to the base material is fixed to a stage using Opteria D692 (thickness of 15 m) pressure-sensitive adhesive manufactured by Lintec Corporation, and the base material is peeled off in a 180° direction at a rate of 5 m/min in an environment of 25° C., was measured with a digital force gauge RZ-1 manufactured by Aikoh Engineering Co., Ltd. The results are shown in Tables 3 to 5 below.

### [Alignment Degree]

The alignment degree was evaluated using the obtained optical film.

Specifically, the transmittance of the light absorption anisotropic layer was measured using an automatic polarizing film measuring device (trade name, VAP-7070, manufactured by Jasco Corporation), and the alignment degree was calculated according to the following expression. The results are shown in Tables 3 to 5 below.

$$Alignment degree : S = ( Ax - Ay ) / [ 2 \times Ay + Ax ]$$

Ax: absorbance in a case where the incident polarized light and the polarizer of the evaluation sample were arranged in cross Nicols
Ay: absorbance in a case where the incident polarized light and the polarizer of the evaluation sample were arranged in para Nicols

$$Ax = - {log}_{10} ( Tx / 100 ) \\ Ay = - {log}_{10} ( Ty / 100 )$$

Tx: transmittance in a case where the incident polarized light and the polarizer of the evaluation sample were arranged in cross Nicols (the incident polarized light is 100%)
Ty: transmittance in a case where the incident polarized light and the polarizer of the evaluation sample were arranged in para Nicols (the incident polarized light is 100%)

### [Uneven Distribution Properties]

For the obtained optical film, a position where the secondary ion intensity derived from the specific compound was the maximum value was evaluated using TOF-SIMS.

In a case where a component of an optical film in a depth direction was analyzed by TOF-SIMS while the film was irradiated with ion beams, a series of operations of performing component analysis on a surface depth region of 1 to 2 nm, entering from 1 nm to several hundreds of nanometers in the depth direction, and performing component analysis of a next surface depth region of 1 to 2 nm were repeated. The positions where the ion intensity was the maximum value were classified as follows. The results are shown in Tables 3 to 5 below.
A: a position where the ion intensity was the maximum value was present within 100 nm from the interface with the support.
B: a position where the ion intensity was the maximum value was not present within 100 nm from the interface with the support.

TABLE 3

| | | | | | | | | Comparative | |
|---|---|---|---|---|---|---|---|---|---|
| | | Example 1 | Example 2 | Example 3 | Example 4 | Example 5 | Example 6 | Example 1 | Example 7 |
| Polymerizable | Type | PA-2 | PA-2 | PA-2 | PA-3 | PA-2 | PA-2 | None | PA-2 |
| macromolecule | Ratio | 4% | 4% | 4% | 4% | 4% | 4% | None | 0.5% |
| having | Weight-average | 18000 | 18000 | 18000 | 18000 | 18000 | 18000 | 18000 | 18000 |
| polymerizable | molecular weight | | | | | | | | |
| group in side | Absolute value of | 1.6 | 1.6 | 1.6 | 1.6 | 1.6 | 1.6 | 1.6 | 1.6 |
| chain | difference in SP | | | | | | | | |
| | value from base | | | | | | | | |
| | material (MPa^{1/2}) | | | | | | | | |
| Photoradical | Type | None | IRGACURE | IRGACURE | IRGACURE | IRGACURE | IRGACURE | None | IRGACURE |
| polymerization | | | QXE-02 | QXE-02 | QXE-02 | QXE-02 | QXE-02 | | QXE-02 |
| initiator | Ratio | None | 3% | 5% | 3% | 3% | 3% | None | 3% |
| Thermal cationic | Type | PAG-1 | PAG-1 | PAG-1 | PAG-1 | PAG-1 | PAG-1 | PAG-1 | PAG-1 |
| polymerization | | | | | | | | | |
| initiator | | | | | | | | | |

| | | | | | | | | |
|---|---|---|---|---|---|---|---|---|
| UV irradiation amount (mJ) onto light | 300 | 300 | 300 | 200 | 400 | 600 | 300 | 300 |
| absorption anisotropic film | | | | | | | | |
| Peeling force (N/25 mm) | 0.05 | 0.10 | 0.20 | 0.05 | 0.15 | 0.20 | 0.50 | 0.35 |
| Alignment degree | 0.96 | 0.96 | 0.96 | 0.96 | 0.96 | 0.96 | 0.96 | 0.96 |
| Uneven distribution properties | A | A | A | A | A | A | B | A |

TABLE 4

| | | | | Compar- | Compar- | | | | | |
|---|---|---|---|---|---|---|---|---|---|---|
| | | | | ative | ative | Example | Example | Example | Example | Example |
| | | Example 8 | Example 9 | Example 2 | Example 3 | 10 | 11 | 12 | 13 | 14 |
| Polymerizable | Type | PA-2 | PA-2 | PA-2 | PA-3 | PA-2 | PA-2 | PA-2 | PA-4 | PA-5 |
| macromolecule | Ratio | 6% | 25% | 4% | 4% | 4% | 4% | 4% | 4% | 4% |
| having | Weight- | 18000 | 18000 | 18000 | 18000 | 3000 | 9000 | 35000 | 18000 | 18000 |
| polymerizable | average | | | | | | | | | |
| group in side | molecular | | | | | | | | | |
| chain | weight | | | | | | | | | |
| | Absolute | 1.6 | 1.6 | 1.6 | 2.2 | 1.6 | 1.6 | 1.6 | 1.4 | 18 |
| | value of | | | | | | | | | |
| | difference | | | | | | | | | |
| | in SP value | | | | | | | | | |
| | from base | | | | | | | | | |
| | material | | | | | | | | | |
| | (MPa^{1/2}) | | | | | | | | | |
| Photoradical | Type | IRGACURE | IRGACURE | None | None | None | None | None | IRGACURE | IRGACURE |
| polymerization | | OXE-02 | OXE-02 | | | | | | OXE-02 | OXE-02 |
| initiator | Ratio | 3% | 3% | None | None | None | None | None | 3% | 3% |
| Thermal | Type | PAG-1 | PAG-1 | None | PAG-1 | PAG-1 | PAG-1 | PAG-1 | PAG-1 | PAG-1 |
| cationic | | | | | | | | | | |
| polymerization | | | | | | | | | | |
| stutrator | | | | | | | | | | |

| | | | | | | | | | |
|---|---|---|---|---|---|---|---|---|---|
| UV irradiation amount | 300 | 300 | 300 | 300 | 300 | 300 | 300 | 300 | 300 |
| (mJ) onto light absorption | | | | | | | | | |
| anisotropic film | | | | | | | | | |
| Peeling force (N/25 mm) | 0.12 | 0.20 | No | 0.45 | 0.03 | 0.04 | 0.10 | 0.10 | 0.37 |
| | | | peeling | | | | | | |
| | | | off | | | | | | |
| Alignment degree | 0.96 | 0.70 | 0 | 0.96 | 0.96 | 0.96 | 0.96 | 0.96 | 0.96 |
| Unevea distribution | A | A | B | B | A | A | A | A | A |
| properties | | | | | | | | | |

TABLE 5

| | | | | | Example | Example | Example |
|---|---|---|---|---|---|---|---|
| | | Example 15 | Example 16 | Example 17 | 18 | 19 | 20 |
| Composition for forming | | B2 | B3 | B4 | B1 | B1 | B1 |
| photo-alignment film | | | | | | | |
| Composition for forming light | | C2 | C2 | C3 | C4 | C5 | C6 |
| absorption anisotropic layer | | | | | | | |
| Polymerizable | Type | PA-2 | PA-2 | PA-2 | PA-2 | PA-2 | PA-2 |
| macromolecule | Ratio | 4% | 4% | 4% | 4% | 4% | 4% |
| having | Weight- | 18000 | 18000 | 18000 | 18000 | 18000 | 18000 |
| polymerizable | average | | | | | | |
| group in side | molecular | | | | | | |
| chain | weight | | | | | | |
| | Absolute | 1.6 | 1.6 | 1.6 | 1.6 | 1.6 | 1.6 |
| | value of | | | | | | |
| | difference | | | | | | |
| | in SP | | | | | | |
| | value from | | | | | | |
| | base | | | | | | |
| | material | | | | | | |
| | (MPa^{1/2}) | | | | | | |
| Photoradical | Type | IRGACURE | IRGACURE | IRGACURE | None | None | None |
| polymerization | | OXE-02 | OXE-02 | OXE-02 | | | |
| initiator | Ratic | 3% | 3% | 3% | None | None | None |
| Thermal | Type | None | PAG-1 | PAG-1 | PAG-1 | PAG-1 | PAG-1 |
| cationic | | | | | | | |
| polymerization | | | | | | | |
| initiator | | | | | | | |

| | | | | | | |
|---|---|---|---|---|---|---|
| UV irradiation amount (mJ) | 300 | 300 | 300 | 300 | 300 | 300 |
| onto light absorption | | | | | | |
| anisotropic film | | | | | | |
| Peeling force (N/25 mm) | 0.03 | 0.08 | 0.10 | 0.05 | 0.05 | 0.05 |
| Alignment degree | 0.92 | 0.92 | — | 0.96 | 0.96 | 0.96 |
| | | | Vertical | | | |
| | | | alignment | | | |
| Uneven distribution properties | A | A | A | A | A | A |

TABLE 6

| | | Example | Example | Example | Example | Example | Example |
|---|---|---|---|---|---|---|---|
| | | 21 | 22 | 23 | 24 | 25 | 26 |
| Composition for forming | | B1 | B1 | B1 | B1 | B1 | B1 |
| photo-alignment film | | | | | | | |
| Polarized UV angle (°) | | Direction of 90° with respect to | | | Direction of 0° with respect to | | |
| | | longitudinal direction of film | | | longitudinal direction of film | | |
| Composition for forming light | | C4 | C7 | C8 | C4 | C7 | C8 |
| absorption anisotropic layer | | | | | | | |
| Thickness of light absorption | | 1.8 | 1.5 | 1.0 | 1.8 | 1.5 | 1.0 |
| anisotropic film (μm) | | | | | | | |
| Polymerizable | Type | PA-2 | PA-2 | PA-2 | PA-2 | PA-2 | PA-2 |
| macromolecule | Ratio | 4% | 4% | 4% | 4% | 4% | 4% |
| having | Weight- | 18000 | 18000 | 18000 | 18000 | 18000 | 18000 |
| polymerizable | average | | | | | | |
| group in side | molecular | | | | | | |
| chain | weight | | | | | | |
| | Absolute | 1.6 | 1.6 | 1.6 | 1.6 | 1.6 | 1.6 |
| | value of | | | | | | |
| | difference | | | | | | |
| | in SP value | | | | | | |
| | from base | | | | | | |
| | material | | | | | | |
| | (MPa^{1/2}) | | | | | | |
| Photoradical | Type | None | None | None | None | None | None |
| polymerization | Ratio | None | None | None | None | None | None |
| initiator | | | | | | | |
| Thermal | Type | PAG-1 | PAG-1 | PAG-1 | PAG-1 | PAG-1 | PAG-1 |
| cationic | | | | | | | |
| polymerization | | | | | | | |
| initiator | | | | | | | |

| | | | | | | |
|---|---|---|---|---|---|---|
| UV irradiation amount (mJ) | 300 | 300 | 300 | 300 | 300 | 300 |
| onto light absorption | | | | | | |
| anisotropic film | | | | | | |
| Peeling force (N/25 mm) | 0.05 | 0.05 | 0.05 | 0.05 | 0.05 | 0.05 |
| Alignment degree | 0.96 | 0.96 | 0.96 | 0.96 | 0.96 | 0.96 |
| Uneven distribution properties | A | A | A | A | A | A |

From the results shown in Tables 3 and 4, in a case where the alignment film did not contain the specific compound, the peeling force of the base material was high, and it was difficult to peel off the base material (Comparative Example 1).

In addition, even in a case where the alignment film contained the specific compound, it was found that, in a case where the specific compound was not unevenly distributed on the base material side, the base material could not be peeled off or the peeling force of the base material was high, thereby it was difficult to peel off the base material (Comparative Examples 2 and 3). In Comparative Example 2, since the alignment film did not contain the thermal cationic polymerization initiator, the alignment film was dissolved in a case where the light absorption anisotropic layer was applied onto the alignment film, and it is considered that the uneven distribution of the specific compound on the base material side was eliminated. In addition, in Comparative Example 3, it is considered that the uneven distribution of the specific compound on the base material side was reduced because the difference in the SP value between the base material and the polymerizable macromolecule is large.

On the other hand, from the results shown in Tables 3 to 6, it was found that, in a case where the alignment film contained the specific compound and the specific compound was unevenly distributed on the base material side, the peeling force between the base material and the alignment film was appropriate, the base material could be easily peeled off in a case of peeling off the base material, and adhesiveness between the base material and the alignment film could be sufficiently ensured during work other than peeling off of the base material (Examples 1 to 20). In addition, it was confirmed that the same performance was obtained for the roll product produced by the continuous coating using a slit die coater (Examples 21 to 26).

From the comparison between Example 2 and Example 9, it was found that, in a case where the content of the specific compound was 0.2% to 20% by mass with respect to the mass of the alignment film, the alignment degree of the liquid crystal layer was improved.

In addition, from the comparison between Example 2 and Example 14, it was found that, in a case where the absolute value of the difference between the SP value of the polymerizable macromolecule and the SP value of the base material was 1.7 MPa^{1/2} or less, it was easy to adjust the peeling force of the substrate to the range of 0.05 to 0.35 N/25 mm.

### Example 27

### [Formation of Light Absorption Anisotropic Layer C9]

An optical film was produced in the same manner as in Example 20, except that the surfactant F-3 was changed to the following surfactant F-4 to form the light absorption anisotropic layer C9 instead of the light absorption anisotropic layer C6.

Surfactant F-4 (weight-average molecular weight: 20,000) (in the formulae, the numerical value described in each repeating unit represents a content (% by mass) of each repeating unit with respect to all repeating units)

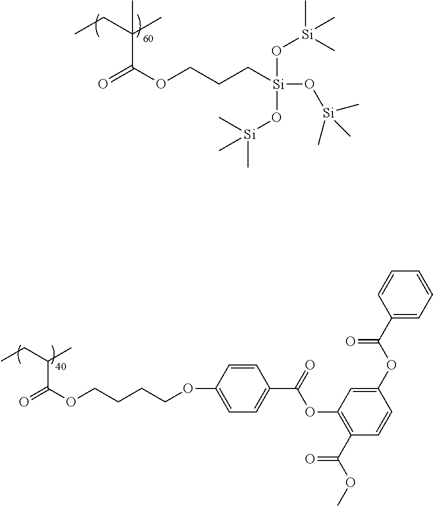

Next, a protective layer D2 was formed on the light absorption anisotropic layer C9 by the same method as in the formation of the protective layer D1 in Example 1, except that the surfactant F-9 was changed to the following surfactant F-10, to obtain an optical film CP27 including the cellulose acylate film A1 (base material), the photo-alignment film B1, the light absorption anisotropic layer C9, and the protective layer D2, which were adjacent to each other in this order.

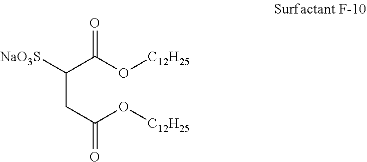

In the optical film CP27, it was found that the evaluation of the uneven distribution properties was A evaluation by the above-described method, and it was found that as in Example 20, the peeling force between the base material and the alignment film was appropriate, and the base material could be easily peeled off in a case of peeling off the base material and adhesiveness between the base material and the alignment film could be sufficiently ensured during work other than peeling off of the base material.

What is claimed is:

1. An optical film comprising, in the following order:
a base material;
an alignment film; and
a liquid crystal layer,
wherein the alignment film contains at least one specific compound selected from the group consisting of a polymerizable macromolecule having a polymerizable group in a side chain and a polymer of the polymerizable macromolecule, and
in a case where a secondary ion intensity derived from the specific compound in the alignment film is measured by a time-of-flight secondary ion mass spectrometry while irradiating the alignment film with an ion beam from a surface on a liquid crystal layer side toward a surface on abase material side, a maximum value of the secondary ion intensity derived from the specific compound is present in a region from the surface of the base material to a 100 nm thickness position.

2. The optical film according to claim 1,
wherein the specific compound is a polymer of the polymerizable macromolecule.

3. The optical film according to claim 1,
wherein the alignment film is a photo-alignment film.

4. The optical film according to claim 3,
wherein the photo-alignment film is an alignment film formed of a composition for forming an alignment film, containing the polymerizable macromolecule and a photo-alignment compound, the polymerizable macromolecule has a radically polymerizable group, and the photo-alignment compound has a cationically polymerizable group.

5. The optical film according to claim 4,
wherein the composition for forming an alignment film contains a polymerization initiator.

6. The optical film according to claim 5,
wherein the polymerization initiator is a photo-radical polymerization initiator.

7. The optical film according to claim 1,
wherein a content of the specific compound is 0.2% to 20% by mass with respect to a mass of the alignment film.

8. The optical film according to claim 1,
wherein the liquid crystal layer contains a dichroic substance.

9. The optical film according to claim 1,
wherein a peeling force in a case of peeling off the base material from the alignment film is 0.03 to 0.40 N/25 mm.

10. The optical film according to claim 1,
wherein an absolute value of a difference between an SP value of the polymerizable macromolecule and an SP value of the base material is 1.7 MPa^{1/2} or less.

11. The optical film according to claim 1,
wherein a weight-average molecular weight of the polymerizable macromolecule is 5,000 to 100,000.

12. The optical film according to claim 1,
wherein the polymerizable group is an acryloyl group or a methacryloyl group.

13. A polarizing plate comprising:
the optical film according to claim 1.

14. An image display device comprising:
the optical film according to claim 1.

15. An image display device comprising:
the polarizing plate according to claim 13.

16. The optical film according to claim 2,
wherein the alignment film is a photo-alignment film.

17. The optical film according to claim 16,
wherein the photo-alignment film is an alignment film formed of a composition for forming an alignment film, containing the polymerizable macromolecule and a photo-alignment compound, the polymerizable macromolecule has a radically polymerizable group, and the photo-alignment compound has a cationically polymerizable group.

18. The optical film according to claim 17,
wherein the composition for forming an alignment film contains a polymerization initiator.

19. The optical film according to claim 18,
wherein the polymerization initiator is a photo-radical polymerization initiator.

20. The optical film according to claim 2,
wherein a content of the specific compound is 0.2% to 20% by mass with respect to a mass of the alignment film.
